(19) United States
(12) Patent Application Publication
(10) Pub. No.: US 2025/0039793 A1
(43) Pub. Date: Jan. 30, 2025

(54) END OF BURST (EOB) MEDIATED ENERGY STATE TRANSITIONING

(71) Applicant: QUALCOMM Incorporated, San Diego, CA (US)

(72) Inventors: Ahmed Elshafie, San Diego, CA (US); Linhai He, San Diego, CA (US); Diana Maamari, San Diego, CA (US)

(21) Appl. No.: 18/357,819

(22) Filed: Jul. 24, 2023

(51) Int. Cl. H04W 52/02; H04W 76/28

(52) U.S. Cl. CPC H04W 52/0235; H04W 76/28

(57) ABSTRACT

This disclosure provides systems, methods, and devices that support end of burst (EOB) mediated energy transitioning. In a first aspect, a method of wireless communication includes detecting an EOB indication. The EOB indication indicates an end of a communicated data frame. The method further includes, in response to detecting the EOB indication, transitioning from an active state at a user equipment (UE) to a low energy state at the UE during a next phase of discontinuous communication.

### TECHNICAL FIELD

Aspects of the present disclosure relate generally to wireless communication systems, and more particularly, to end of burst (EOB) mediated energy state transitioning. Some features may enable and provide improved communications, including efficient resource utilization and reduced energy consumption at network devices.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

As wireless communication devices become increasingly a part of daily life, there is an increased drive to provide wireless communication capability to a broader variety of devices. In particular, there is demand to expand current wireless communication and connectivity capabilities of mobile phones and computers to less complicated devices such as wireless sensors, internet of things (IoT) devices, smart devices, and the like. A challenge with extending wireless communication capabilities to such devices is that the power consumption associated with wireless communications may exceed the limited battery or power resources of these devices. Additionally, this power consumption challenge may be exacerbated when a device, such as a UE, processes complex data such as streaming video traffic. In particular, to conserve power, the UE should be able to quickly enter into a low energy state (e.g., a “sleep mode” or a “quiescent state”) between data frames by, for example, terminating a discontinuous communication active time of the UE quickly and efficiently between data frames.

Prior art systems typically employ two different techniques to attempt to transition the UE into a quiescent state when the UE is in a discontinuous communication active time. In one technique, a network entity, such as a base station, sends the UE a discontinuous reception (DRX) medium access control (MAC) control element (CE) to cause the UE to transition into the quiescent state. In another technique, the UE implements and applies a DRX inactivity timer for determining when to transition into the quiescent state. Both techniques have drawbacks when the UE is operating during a discontinuous communication active time period. In particular, to send the UE a DRX MAC CE, the base station usually possesses information corresponding to a time at which the UE has completed transmission or reception of a last data frame. However, when the UE receives or transmits complex data, such as video data, each frame of the video data varies in time. Accordingly, the base station cannot easily predict when the UE has finished transmitting a video frame even by analyzing packet-level statistics. Therefore, the base station lacks information as to when to send the DRX MAC CE to the UE, resulting in the UE remaining in an active operating mode instead of transitioning to the quiescent state and failing to conserve sufficient power. Setting a DRX inactivity timer likewise is challenging due to the short inter-frame interval between certain types of data, such as video data. Further, the time period set by the DRX inactivity timer usually can be no shorter than typical scheduling gaps. Accordingly, the time period set by the DRX inactivity timer is likely to be short, with the result that the UE only will have a short amount of time to enter a quiescent state between data frames, thereby resulting in minimal power savings. As an example, a typical scheduling gap on a frequency 1 (FR 1) carrier is approximately 10 milliseconds (ms). If an inter-frame interval is 33.33 ms, a video frame on average takes approximately 15 ms to complete, and the DRX inactivity timer sets a time period of 10 ms, then the UE only enters a quiescent state of 8.33 ms (e.g., 33.33 ms-15 ms-10 ms=8.33 ms), which may not save sufficient power.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication performed by a user equipment (UE) includes detecting an end of burst (EOB) indication, the EOB indication indicating an end of a communicated data frame. The method further includes, in response to detecting the EOB indication, transitioning from an active state at the UE to a low energy state at the UE during a next phase of discontinuous communication.

In an additional aspect of the disclosure, an apparatus for wireless communication includes at least one processor and a memory coupled to the at least one processor. The at least one processor is configured to detect an end of burst (EOB) indication, the EOB indication indicating an end of a communicated data frame. The at least one processor is further configured to, in response to detection of the EOB indication, transition from an active state to a low energy state during a next phase of discontinuous communication.

In an additional aspect of the disclosure, a non-transitory computer-readable storage medium storing instructions that, when executed by one or more processors, cause the one or more processors to perform operations for wireless communication. The operations include detecting an end of burst (EOB) indication, the EOB indication indicating an end of a communicated data frame. The operations further include, in response to detecting the EOB indication, transitioning from an active state to a low energy state during a next phase of discontinuous communication.

In an additional aspect of the disclosure, an apparatus for wireless communication is disclosed. The apparatus includes means for detecting an end of burst (EOB) indication, the EOB indication indicating an end of a communicated data frame. The apparatus further includes means for transitioning from an active state to a low energy state during a next phase of discontinuous communication, the transitioning performed in response to detecting the EOB indication.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 shows a diagram illustrating an example disaggregated base station architecture according to one or more aspects.

FIG. 4 is a block diagram illustrating an example wireless communication system that supports end of burst (EOB) mediated energy state transitioning in an uplink (UL) mode of operation of a UE according to one or more aspects.

FIG. 5 is a block diagram illustrating an example wireless communication system that supports EOB mediated energy state transitioning in a downlink (DL) mode of operation of the UE according to one or more aspects.

FIG. 6 is a ladder diagram illustrating an example process that supports EOB mediated energy state transitioning based on bandwidth part (BWP) switching in the UL mode of operation of the UE according to one or more aspects.

FIG. 7 is a diagram of an example of BWP switching that supports EOB mediated energy state transitioning according to one or more aspects.

FIG. 8 is a ladder diagram illustrating an example process that supports EOB mediated energy state transitioning based on BWP switching in the DL mode of operation of the UE according to one or more aspects.

FIG. 9 is a ladder diagram illustrating an example process that supports EOB mediated energy state transitioning based on refraining, by a UE, from decoding an UL grant according to one or more aspects.

FIG. 10 is a ladder diagram illustrating an example process that supports EOB mediated energy state transitioning based on monitoring for scheduling downlink control (DCI) and not for other DCI according to one or more aspects.

FIG. 11 is a ladder diagram illustrating an example process that supports EOB mediated energy state transitioning based on search space set group (SSSG) switching in an UL mode of operation of the UE according to one or more aspects.

FIG. 12 is a ladder diagram illustrating an example process that supports EOB mediated energy state transitioning based on SSSG switching in a DL mode of operation of the UE according to one or more aspects.

FIG. 13 is a flow diagram illustrating an example process that supports EOB mediated energy state transitioning according to one or more aspects.

FIG. 14 is a block diagram of an example UE that supports EOB mediated energy state transitioning according to one or more aspects.

FIG. 15 is a flow diagram illustrating an example process that supports EOB mediated energy state transitioning according to one or more aspects.

FIG. 16 is a block diagram of an example base station that supports EOB mediated energy state transitioning according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support end of burst (EOB) mediated energy state transitioning. For example, the present disclosure provides techniques for enabling a user equipment (UE) to quickly and efficiently transition from an active state, such as a high energy state, to a low energy state, such as a quiescent state, during a next phase of discontinuous communication. To illustrate, the UE may detect an EOB indication, which, in some examples, may be detected during a discontinuous communication active phase of a discontinuous communications time period. For example, the UE may detect an EOB indication associated with an end of a communicated data frame, such as an end of a video burst, an end of a communicated data packet, or an end of a packet data unit (PDU), that is generated by an application executed by the UE or that is received from a network entity. The EOB indication may indicate an end of a communicated data frame, such as the end of a communicated frame of video data. In response to detecting the EOB indication, the UE may transition from the active state to the low energy state during the next phase of discontinuous communication. As an example, the UE may transition from the active state to the low energy state by performing bandwidth part (BWP) switching from a first BWP to a second BWP that has a smaller size than the first BWP, which may use less energy to perform wireless communication operations. As another example, the UE may transition from the active state to the low energy state by refraining from decoding an UL grant or by monitoring for scheduling downlink control information (DCI) and not for other DCI (e.g., non-scheduling DCI). As yet another example, the UE may transition from the active state to the low energy state by switching from a first search space set group (SSSG) to a second SSSG that involves or is associated with fewer physical downlink control channel (PDCCH) monitoring occasions than the first SSSG.

Particular implementations of the subject matter described in this disclosure may be implemented to realize one or more of the following potential advantages or benefits. In some aspects, the present disclosure facilitates a quick and efficient transition from an active state at the UE to a low energy state at the UE based on detection of an EOB indication. In this manner, the UE is able to conserve energy, such as by operating in a low energy state (e.g., a quiescent state) that communicates via a smaller BWP, via a SSSG with fewer PDCCH monitoring occasions, or by refraining from performing certain operations. By avoiding delays in transitioning to the quiescent state, the UE may be able to remain in the quiescent state for a longer period of time, prior to a next phase of discontinuous communication, than if the UE were implementing other power state transitioning techniques, thereby reducing power consumption at the UE.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHZ) and FR2 (24.25 GHZ-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHZ, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

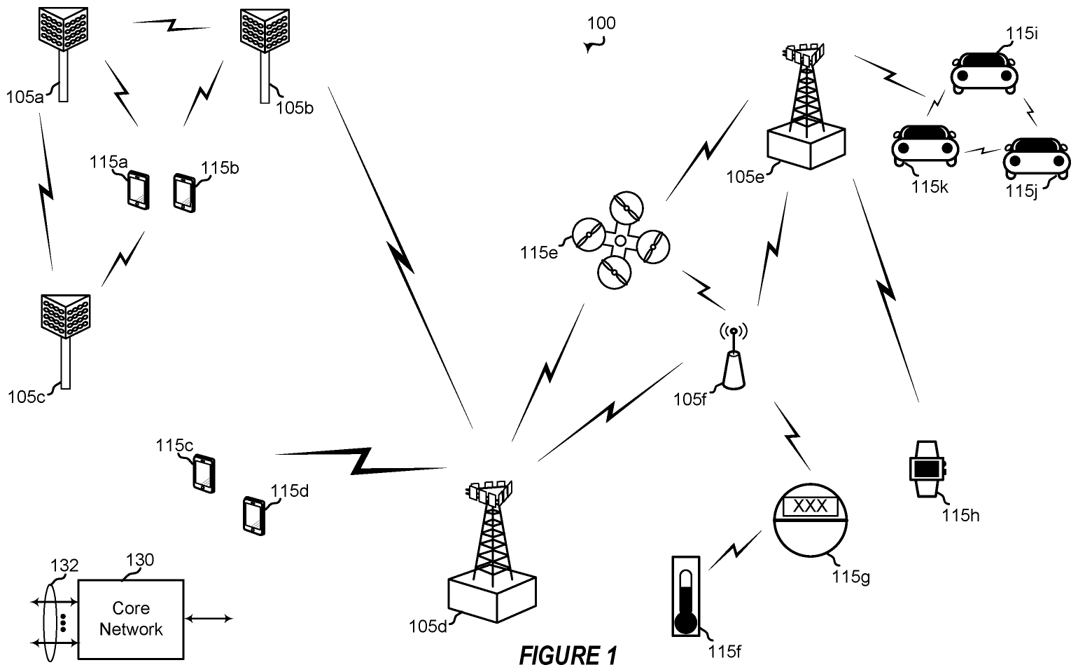

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105c.

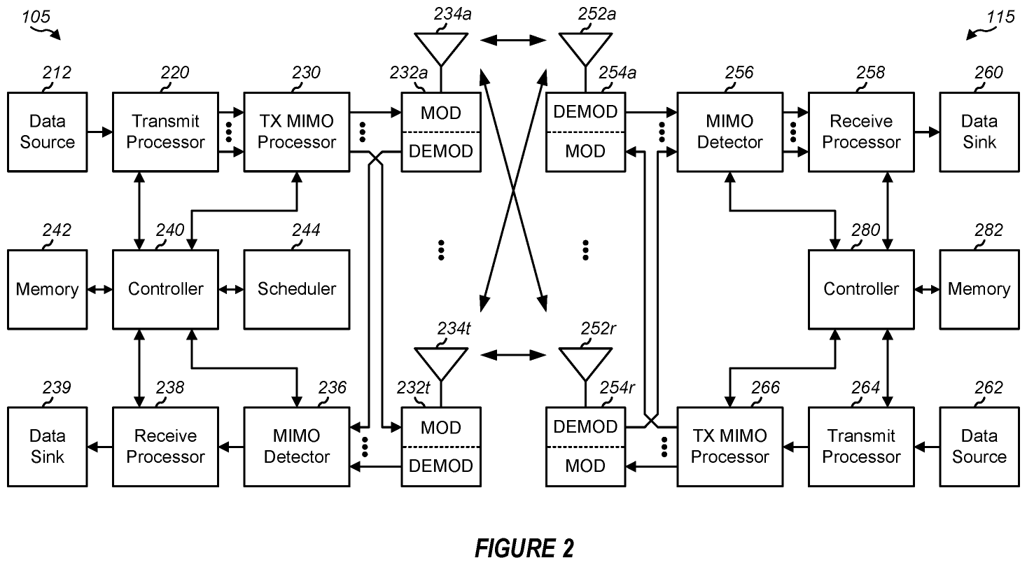

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

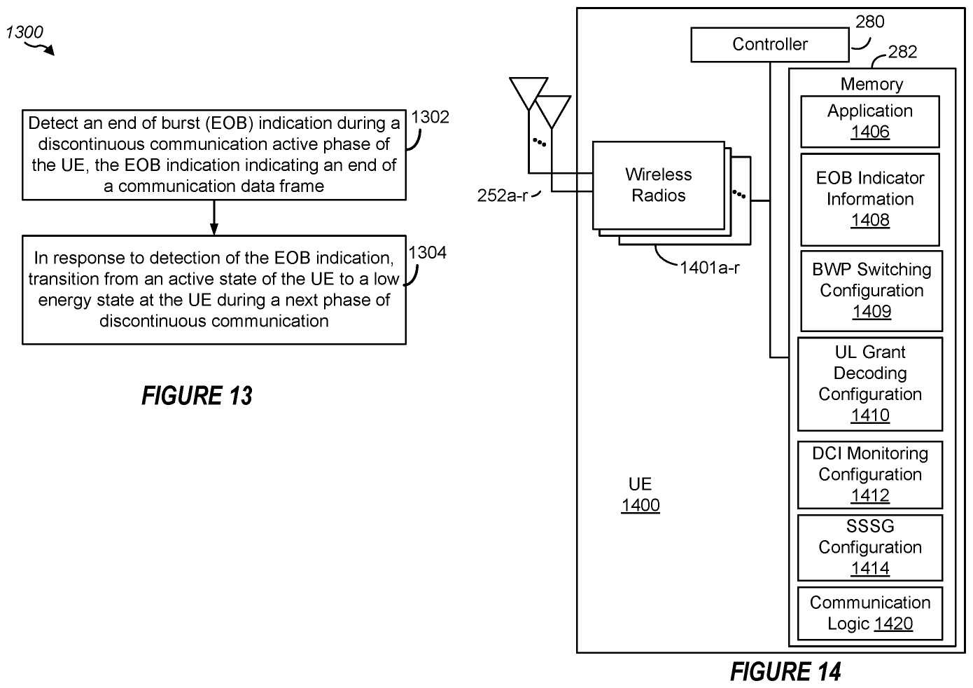

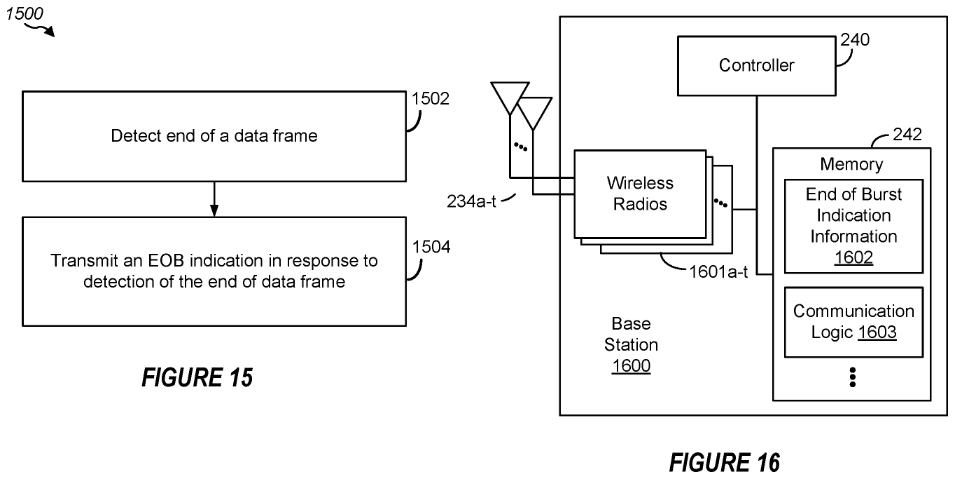

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 13 and 15, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

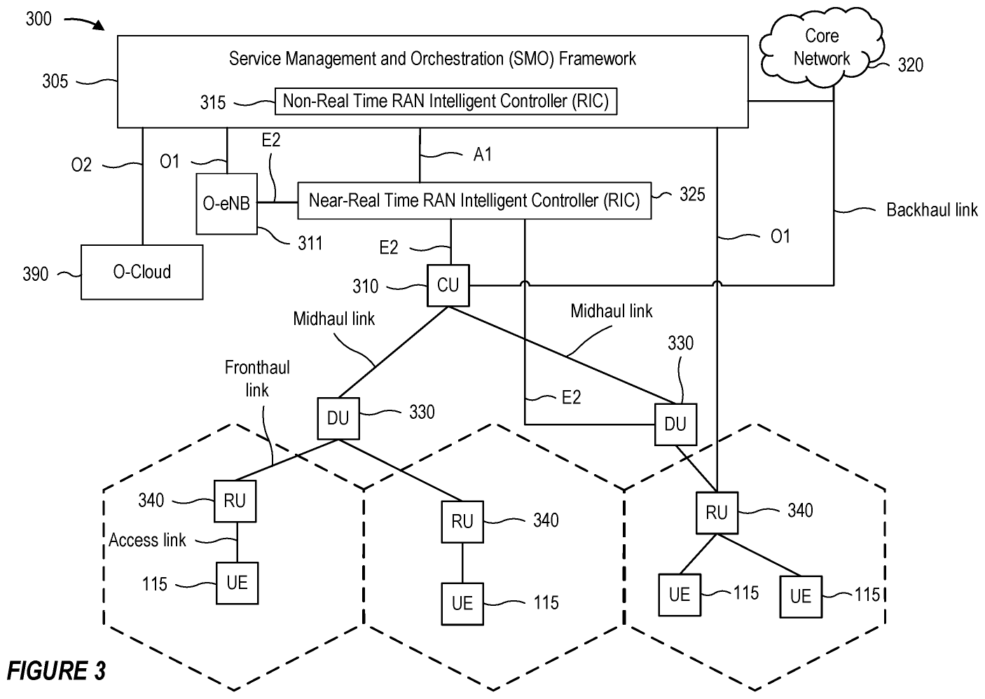

FIG. 3 shows a diagram illustrating an example disaggregated base station 300 architecture. The disaggregated base station 300 architecture may include one or more central units (Cus) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). Core network 320 may include or correspond to core network 130. A CU 310 may communicate with one or more distributed units (Dus) 330 via respective midhaul links, such as an F1 interface. The Dus 330 may communicate with one or more radio units (Rus) 340 via respective fronthaul links. The Rus 340 may communicate with respective UEs 115 via one or more radio frequency (RF) access links. In some implementations, the UE 115 may be simultaneously served by multiple Rus 340.

Each of the units, i.e., the Cus 310, the Dus 330, the Rus 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more Rus 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more Rus 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 115. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, Cus 310, Dus 330, Rus 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more Rus 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more Cus 310, one or more Dus 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As described herein, a node (which may be referred to as a node, a network node, a network entity, or a wireless node) may include, be, or be included in (e.g., be a component of) a base station (e.g., any base station described herein), a transmission and reception point (TRP), a UE (e.g., any UE described herein), a network controller, an apparatus, a device, a computing system, an integrated access and backhauling (IAB) node, a distributed unit (DU), a central unit (CU), a remote unit (RU), a core network, a LFM, and/or a another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

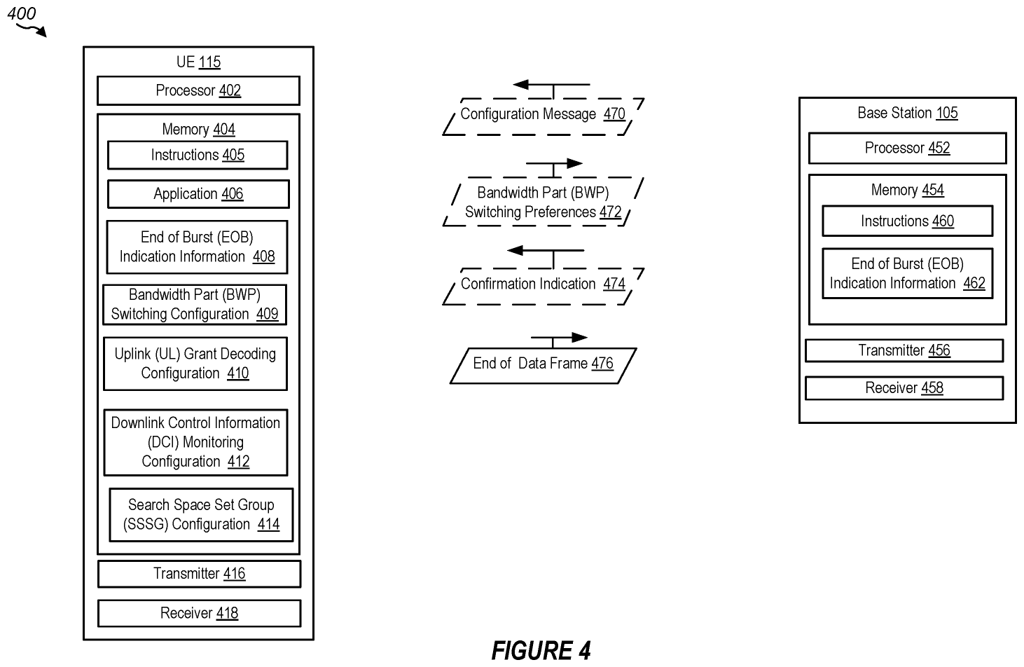

FIG. 4 is a block diagram of an example wireless communications system 400 that supports end of burst (EOB) mediated energy state transitioning in an UL mode of operation according to one or more aspects. In some examples, wireless communications system 400 may implement aspects of wireless network 100. Wireless communications system 400 includes UE 115 and base station 105, which also may be referred to as a network entity. Although one UE 115 and one base station 105 are illustrated, in some other implementations, wireless communications system 400 may generally include a plurality of UEs, a plurality of base stations, or a combination thereof.

UE 115 may include a variety of components (such as structural, hardware components) used for carrying out one or more functions described herein. For example, these components may include one or more processors 402 (hereinafter referred to collectively as “processor 402”), one or more memory devices 404 (hereinafter referred to collectively as “memory 404”), one or more transmitters 416 (hereinafter referred to collectively as “transmitter 416”), and one or more receivers 418 (hereinafter referred to collectively as “receiver 418”). In some implementations, UE 115 may include an interface (e.g., a communication interface) that includes transmitter 416, receiver 418, or a combination thereof. Processor 402 may be configured to execute instructions 405 stored in memory 404 to perform the operations described herein. In some implementations, processor 402 includes or corresponds to one or more of receive processor 258, transmit processor 264, and controller 280, and memory 404 includes or corresponds to memory 282.

Memory 404 includes or is configured to store instructions 405, application 406, EOB indication information 408, bandwidth part (BWP) switching configuration 409, uplink (UL) grant decoding configuration 410, downlink control information (DCI) monitoring configuration 412, and search space set group (SSSG) configuration 414.

Application 406 (e.g., a “higher layer” application) may be executed by UE 115 to cause UE 115 to perform operations, including generation of an EOB indication at an end of a communicated data frame, such as end of data frame 476. For instance, application 406 may signal processor 402 to generate an EOB indication based on EOB indication information 408 in response to the end of the communicated data frame. As an example, application 406 may be a video streaming application. EOB indication information 408 may include or correspond to data, an instruction, or both, configurable to cause processor 402 to generate the EOB indication. BWP switching configuration 409 may include or correspond to data, an instruction, or both, configurable to cause processor 402 to switch from communicating with base station 105 via a first BWP to communicating with base station 105 via a second BWP (e.g., perform a BWP switching operation). UL grant decoding configuration 410 may include or correspond to data, an instruction, or both, configurable to cause processor 402 to refrain from decoding one or more UL grants (e.g., received from base station 105 via DCI). DCI monitoring configuration 412 may include or correspond to data, an instruction, or both, configurable to cause processor 402 to monitor for scheduling DCI and not for other DCI, such as non-scheduling DCI. SSSG configuration 414 may include or correspond to data, an instruction, or both, to switch from communicating with base station 105 according to a first SSSG to communicating with base station 105 according to a second SSSG.

Transmitter 416 is configured to transmit reference signals, control information and data to one or more other devices, and receiver 418 is configured to receive references signals, synchronization signals, control information and data from one or more other devices. For example, transmitter 416 may transmit signaling, control information and data to, and receiver 418 may receive signaling, control information and data from, base station 105. In some implementations, transmitter 416 and receiver 418 may be integrated in one or more transceivers. Additionally or alternatively, transmitter 416 or receiver 418 may include or correspond to one or more components of UE 115 described with reference to FIG. 2.

In some implementations, UE 115 may include one or more antenna arrays. The one or more antenna arrays may be coupled to transmitter 416, receiver 418, or a communication interface. The antenna array may include multiple antenna elements configured to perform wireless communications with other devices, such as with base station 105. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of UE 115. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

Base station 105, also referred to as a network entity, may include a variety of components (such as structural, hardware components) used for carrying out one or more functions described herein. For example, these components may include one or more processors 452 (hereinafter referred to collectively as “processor 452”), one or more memory devices 454 (hereinafter referred to collectively as “memory 454”), one or more transmitters 456 (hereinafter referred to collectively as “transmitter 456”), and one or more receivers 458 (hereinafter referred to collectively as “receiver 458”). In some implementations, base station 105 may include an interface (e.g., a communication interface) that includes transmitter 456, receiver 458, or a combination thereof. Processor 452 may be configured to execute instructions 460 stored in memory 454 to perform the operations described herein. In some implementations, processor 452 includes or corresponds to one or more of receive processor 238, transmit processor 220, and controller 240, and memory 454 includes or corresponds to memory 242.

Memory 454 includes or is configured to store instructions 460 and EOB indication information 462. EOB indication information 462 may include or correspond to EOB indication information 408 described above with reference to UE 115.

Transmitter 456 is configured to transmit reference signals, synchronization signals, control information and data to one or more other devices, and receiver 458 is configured to receive reference signals, control information and data from one or more other devices. For example, transmitter 456 may transmit signaling, control information and data to, and receiver 458 may receive signaling, control information and data from, UE 115. In some implementations, transmitter 456 and receiver 458 may be integrated in one or more transceivers. Additionally or alternatively, transmitter 456 or receiver 458 may include or correspond to one or more components of base station 105 described with reference to FIG. 2.

In some implementations, base station 105 may include one or more antenna arrays. The antenna array may include multiple antenna elements configured to perform wireless communications with other devices, such as with UE 115. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of base station 105. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, wireless communications system 400 implements a 5G NR network. For example, wireless communications system 400 may include multiple 5G-capable UEs 115 and multiple 5G-capable base stations 105, such as UEs and base stations configured to operate in accordance with a 5G NR network protocol such as that defined by the 3GPP. In some other implementations, wireless communications system 400 implements a 6G network.

During operation of wireless communications system 400, UE 115 may transmit end of data frame 476 (e.g., a last frame of a data burst) to base station 105. For example, end of data frame 476 may correspond to a last frame of data, such as video data, that UE 115 transmits to base station 105. Although described as an end of data frame 476, the end of the data frame may include or correspond to, or in other implementations be replaced by, an end of a data burst (e.g., a TX burst), an end of a data packet, or an end of a packet data unit (PDU), as non-limiting examples. In response to transmission of end of data frame 476, application 406 may generate an EOB indication. The EOB indication may indicate an end of a communicated data frame or a communication burst, such as end of data frame 476. In some implementations, the EOB indication may include or correspond to a zero buffer indication that is generated based on a buffer, such as a transmit (TX) buffer, becoming empty. However, in other implementations, the EOB indication may include or correspond to a signal dedicated to indicating that end of data frame 476 is the last frame of a data burst or TX burst. For instance, processor 402, executing application 406, may generate the EOB indication based on EOB indication information 408. Hence, processor 402 may detect an EOB indication by receiving an UL EOB indication from application 406 executed by UE 115. Processor 402 may detect the EOB indication. For example, processor 402 may detect the EOB indication during a discontinuous communication active phase of a discontinuous communication time period associated with communication between UE 115 and base station 105. In the example shown in FIG. 4, the communication performed by UE 115 is in the UL direction, and thus the discontinuous communication active phase is a discontinuous transmission (DTX) active phase. In response to detecting the EOB indication, processor 402 may transition UE 115 from an active state (e.g., an active operating mode) to a low energy state (e.g., a quiescent state) during a next phase of the discontinuous communication time period. The next phase of the discontinuous communication time period may be an idle or inactive phase and may last until a next frame of data, such as a next frame of video data, is ready to be transmitted by UE 115 to base station 105.

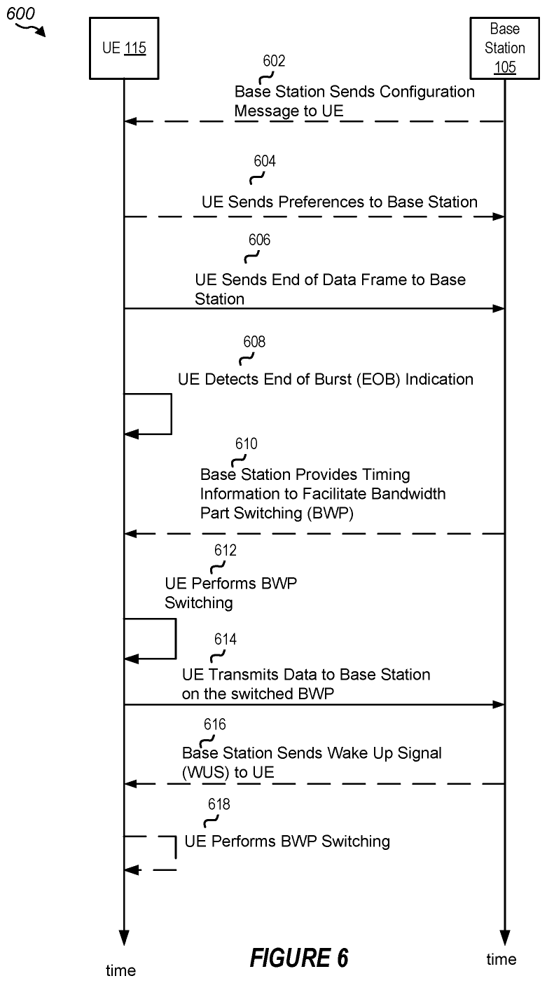

As explained in more detail with reference to FIGS. 6, 9, and 11, to transition from the active state to the low energy state or to operate in the low energy state, UE 115 may execute different types of functionality. For example, in some implementations, UE 115 may transition from the active state to the low energy state by performing BWP switching, as explained with reference to FIG. 6, which is a ladder diagram illustrating an example process 600 that supports EOB mediated energy state transitioning based on BWP switching in an UL mode of operation according to one or more aspects. In implementations in which the state switching is BWP switching. UE 115 may switch from communicating with base station 105 via a first BWP to communicating with base station 105 via a second BWP. The second BWP may have a smaller size than the first BWP. In some such implementations, UE 115 may send BWP switching preferences 472 to base station 105 as part of a configuration process for BWP switching with base station 105. BWP switching preferences 472 may indicate mechanisms, parameters, and configurations associated with BWP switching, such as frequency ranges associated with the first BWP and the second BWP, sizes of the first BWP and the second BWP, or the like.

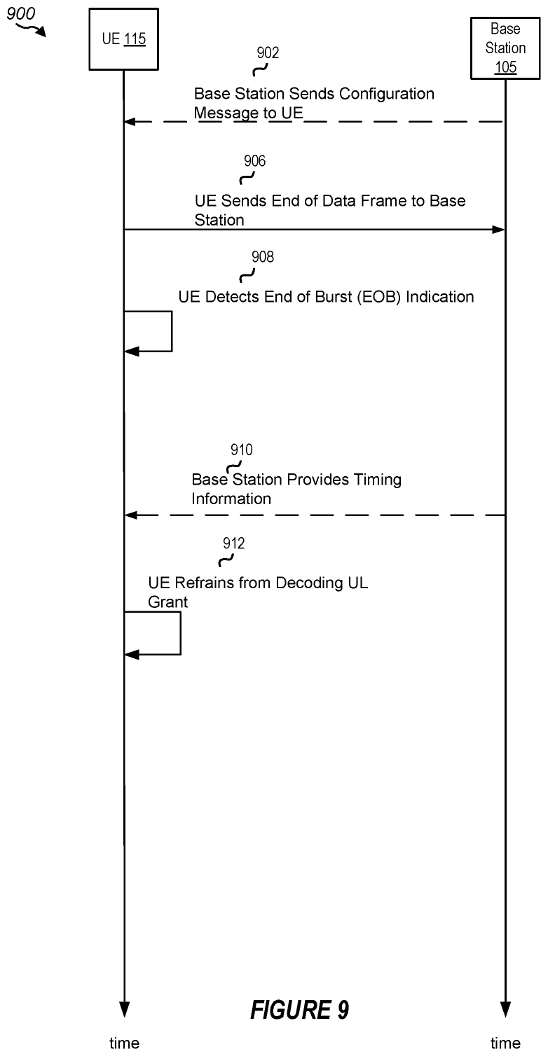

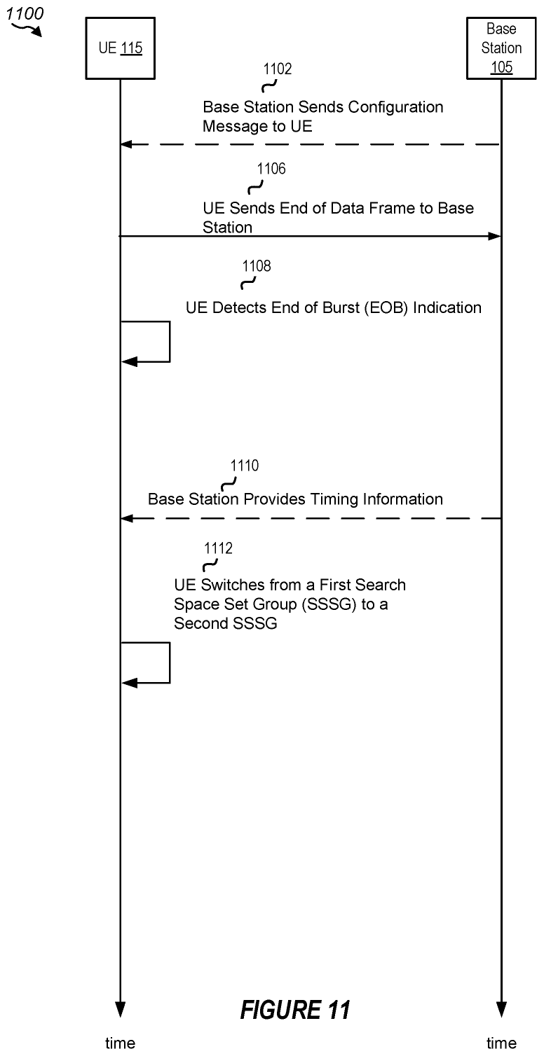

In other implementations as explained with reference to FIG. 9, which is a ladder diagram illustrating an example process 900 that supports EOB mediated energy state transitioning based on refraining, by UE 115, from decoding an UL grant according to one or more aspects, UE 115 may operate in the low energy state by refraining from decoding UL grants received from base station 105. In yet other implementations as explained with reference to FIG. 11, which is a ladder diagram illustrating an example process 1100 that supports EOB mediated energy state transitioning based on SSSG switching in an UL mode of operation according to one or more aspects, UE 115 may transition from the active state to the low energy state by switching from communicating with base station 105 according to a first SSSG to communicating with base station 105 according to a second SSSG. In some implementations, regardless of whether UE 115 performs BWP switching, refrains from decoding UL grants, or switches SSSGs, UE 115 may receive configuration message 470 from base station 105. Configuration message 470 may include data, an instruction, or both, to configure UE 115 to perform one or more of the above-described functionalities when operating in the low energy state. For example, configuration message 470 may include timing data so that UE 115 is configured to set a timer for a period of time during which UE 115 operates in the low energy state. Additionally, in some implementations, UE may receive confirmation indication 474 from base station 105. Confirmation indication 474 may be an indication that confirms that the network is prepared for UE 115 to transition from the active state to the low energy state and may be in addition to the EOB indication.

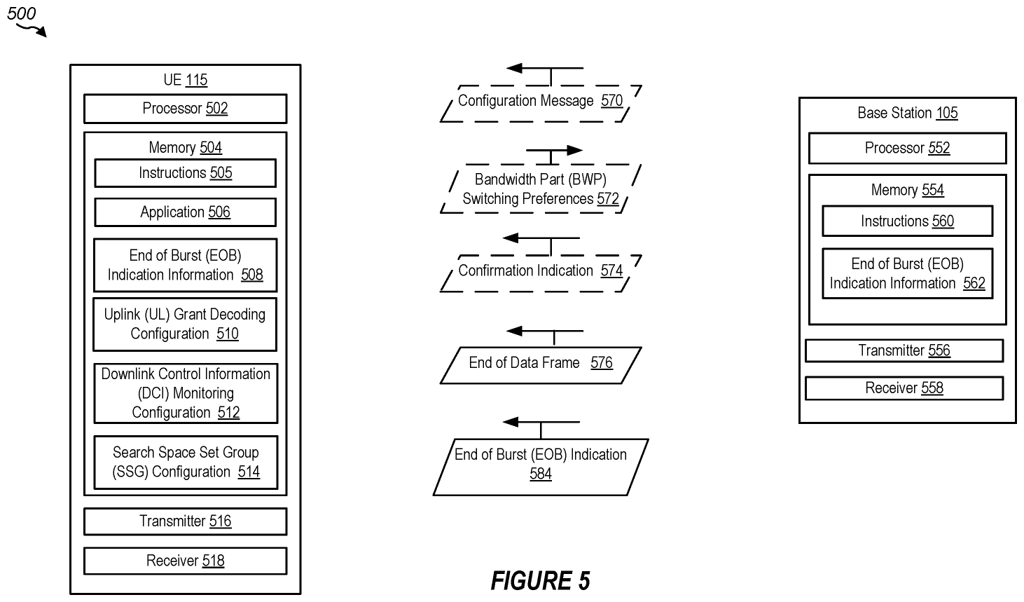

FIGS. 4, 6, 9, and 11 illustrate UE 115 operation in an UL mode in which UE 115 transmits data, such as video data, to base station 105. However, in some implementations, as described with reference to FIGS. 5, 8, 10, and 12, UE 115 may operate in a downlink (DL) mode in which UE 115 receives data, such as video data, from base station 105. Referring to FIG. 5, a block diagram of an example wireless communications system 500 that supports EOB mediated energy state transitioning in a DL mode of operation is depicted according to one or more aspects. While the components of UE 115 and base station 105 in FIG. 5 are identical to the components of UE 115 and base station 105 illustrated in FIG. 4, operation of wireless communications system 500 in the DL mode is subtly different from operation of wireless communication system 400 in the UL mode. To illustrate, in a DL mode of operation, base station 105 may transmit end of data frame 576 (e.g., a last frame of a data burst) to UE 115. For example, end of data frame 576 includes or corresponds to a last frame of data, such as video data, sent by base station 105 to UE 115. Additionally, base station 105 sends EOB indication 584 to UE 115. EOB indication 584 may indicate an end of a communicated data frame or a communication burst, such as end of data frame 576. In some implementations, EOB indication 584 may include or correspond to a zero buffer indication that is generated based on a buffer, such as a transmit (TX) buffer, becoming empty. However, in other implementations, the EOB indication may include or correspond to a signal dedicated to indicating that end of data frame 576 is the last frame of a data burst or TX burst. Accordingly, UE 115 detects EOB indication 584 by receiving EOB indication 584 from base station 105. In particular, processor 502 of UE 115 may detect EOB indication 584 during a communication operation. For instance, the communication operation may be a discontinuous communication active phase of a discontinuous communication time period associated with communication between UE 115 and base station 105. In the example shown in FIG. 5, the communication performed by UE 115 is in the DL direction, and thus the discontinuous communication active phase is a discontinuous reception (DRX) active phase. In response to detecting EOB indication 584, UE 115 transitions from an active state (e.g., an active operating mode) to a low energy state (e.g., a quiescent state) during a next phase of the discontinuous communication time period. The next phase of the discontinuous communication time period may be an idle or inactive phase and may last until a next frame of data is ready to be transmitted, by base station 105, to UE 115. In some implementations, base station 105 sends EOB indication 584 to UE 115 concurrently with end of data frame 576, while in other implementations, base station 105 sends EOB indication 584 to UE 115 after sending end of data frame 576.

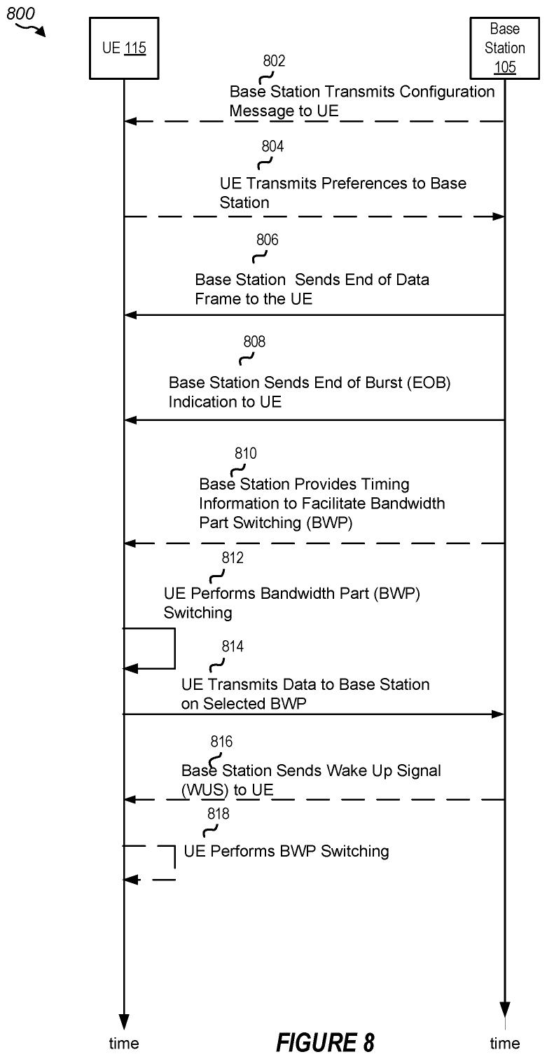

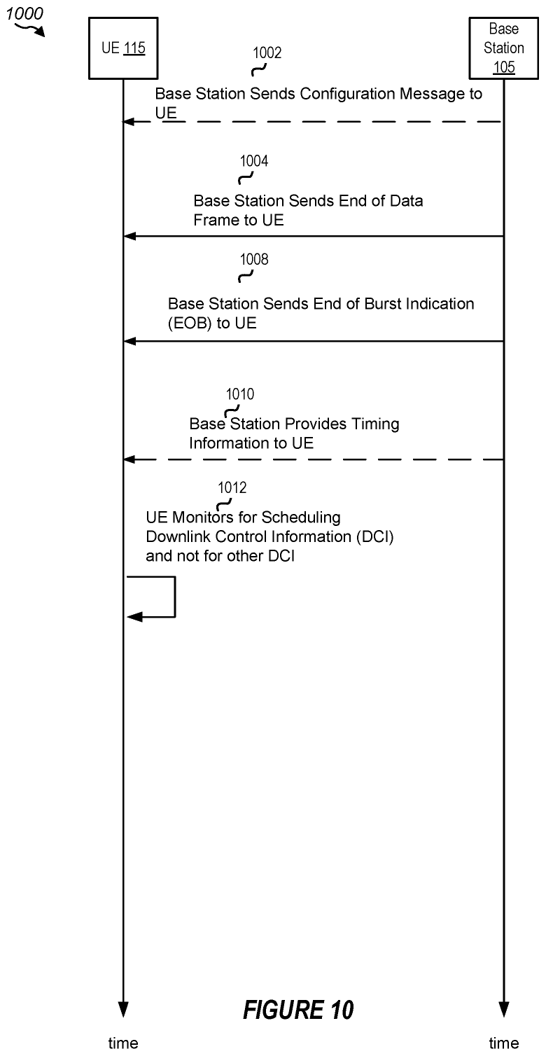

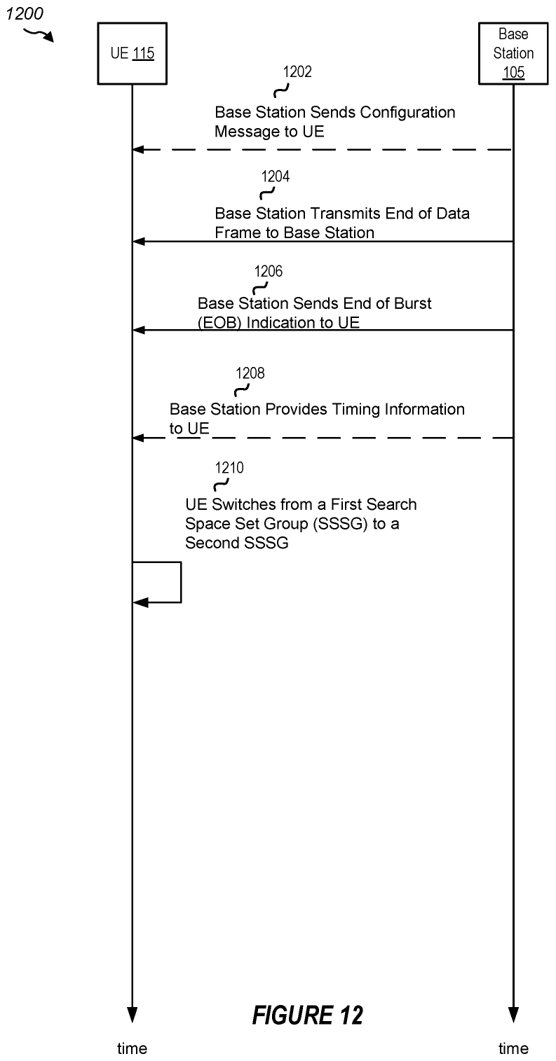

As explained in more detail with reference to FIGS. 8, 10, and 12, to transition from the active state to the low energy state or to operate in the low energy state, UE 115 may execute different types of functionality. For example, in some implementations, UE 115 may transition from the active state to the low energy state by performing BWP switching, as explained with reference to FIG. 8, which is a ladder diagram illustrating an example process 800 that supports EOB mediated energy state transitioning based on BWP switching in a DL mode of operation of UE 115 according to one or more aspects. BWP switching performed in the DL may be similar to BWP switching performed in the UL other than the direction of the communications being performed. In some other implementations as explained with reference to FIG. 10, UE 115 may transition from the active state to the low energy state and then operate in the low energy state by monitoring for scheduling DCI and not for other DCI, such as non-scheduling DCI. In some other implementations as explained with reference to FIG. 12, UE 115 may transition from the active state to the low energy state by switching communicating or monitoring according to SSSGs in response to receipt, at UE 115, of EOB indication 584.

When operating in an UL mode of operation, a DL mode of operation, or both, UE 115 may transition from the active state to the low energy state by performing BWP switching from communicating with base station 105 via a first BWP to communicating with base station 105 via a second BWP. An example of BWP switching in the UL mode of operation is provided in FIG. 6, which depicts a ladder diagram illustrating an example process 600 that supports EOB mediated energy state transitioning based on BWP switching in the UL mode of operation of UE 115 according to one or more aspects. At 602, base station 105 may send a configuration message to UE 115, such as configuration message 470 of FIG. 4. In some implementations, configuration message 470 may be received during a radio resource control (RRC) procedure between UE 115 and base station 105. Configuration message 470 may include one or more parameters associated with performing BWP switching from the first BWP to the second BWP, such as a size of the second BWP, a size of the first BWP, a frequency range associated with the first BWP, a frequency range associated with the second BWP, a size reduction between the first BWP and the second BWP, a center frequency of the first BWP, a center frequency of the second BWP, other parameters, or a combination thereof. The size of a BWP may correspond to a slot length, in time, of the BWP. As a non-limiting example and as may be specified in a 5G new radio (NR) standard or specification, a BWP size may be one of four designated sizes and may be denoted u. The four different sizes may be as follows: μ=0, corresponding to a BWP size of 1 ms; μ=1, corresponding to a BWP size of 0.5 ms; μ=2, corresponding to a BWP size of 0.25 ms; and μ=3, corresponding to a BWP size of 0.125 ms. Moreover, the one or more parameters may indicate a duration of a time period that the UE 115 and the base station 105 are to communicate via the second BWP. To illustrate, configuration message 470 may cause processor 402 of UE 115 to instantiate or implement a timer configured to measure an amount of time during which UE 115 is to communicate via the second BWP.

Alternatively, UE 115 may track the time period in other manners, such as based on detection of one or more trigger conditions. Upon expiration of the time period, UE 115 may revert to communicating with base station 105 via the first BWP. Additionally or alternatively, the size of the BWP may correspond to frequency resources allocated to the BWP, such as resource blocks (RBs) or interlaced RBs of the BWP.

At 604, UE 115 may send BWP switching preferences to base station 105, such as BWP switching preferences 472 of FIG. 4. For example, UE 115 may send BWP switching preferences 472 to base station 105 in response to receipt of configuration message 470. BWP switching preferences 472 may include or indicate a BWP switching mechanism (e.g., a preferred BWP switching mechanism by UE 115), a duration of a current DTX active phase, a start time of a next DTX phase (e.g., a DTX idle phase), a duration of the next DTX phase (e.g., a DTX idle phase), or a combination thereof. Additionally or alternatively, BWP switching preferences 472 may include an identification of a preferred second BWP, a preferred size of the second BWP, a preferred duration for communicating via the second BWP, or a combination thereof. In some implementations, BWP switching preferences 472 may indicate a preference for switching to a BWP having a particular size (e.g., one of μ=0, 1, 2, or 3), a preference for switching to a default BWP, a preference for reducing a BWP size from a first BWP size to a second BWP size, a preferred time period for communicating via the first BWP, or a preferred time period for communicating via the second BWP.

At 606, UE 115 sends an end of data frame to base station 105, such as end of data frame 476 of FIG. 4. End of data frame 476 may include or correspond a last frame of a data burst or a TX burst sent by UE 115 to base station 105. In some implementations, the data may include or correspond to video data such that a duration of each frame of data may vary in time. At 608, UE 115 detects an EOB indication. For example, processor 402 of UE 115 may receive an UL EOB indication from application 406 executed at UE 115. In some implementations, application 406 may send the UL EOB indication to processor 402 in response to transmission, by UE 115, of end of data frame 476.

While FIG. 6 depicts that UE 115 detects the EOB indication after UE 115 sends end of data frame 476 to base station 105, UE 115 may detect the EOB indication at least partially concurrently with transmission of data frame 476 to base station 105 or prior to transmission of data frame 4765 to base station 105. To elaborate, application 406, such as video processing software, may detect that UE 115 is transmitting or will transmit end of data frame 476. Accordingly, application 406 may generate the EOB indication simultaneously with transmission, by UE 115, of end of data frame 476 or prior to transmission, by UE 115, of end of data frame 476. Therefore, since UE 115 may detect the EOB indication while end of data frame 476 is transmitted or even before end of data frame 476 is transmitted, UE 115 may be configured to quickly and efficiently transition from the active state to the quiescent state by initiating operations to perform BWP switching.

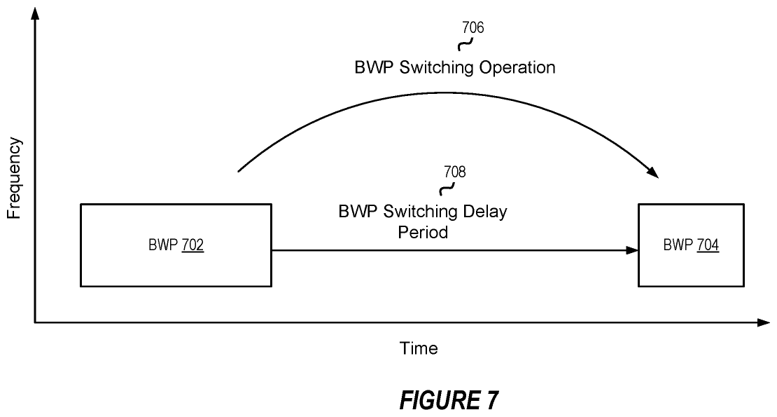

At 610, base station 105 may optionally provide timing information to UE 115 to facilitate BWP switching. The timing information may indicate a BWP switching delay period, or stated another way, a time period that elapses before UE 115 switches from communicating via the first BWP to communicating via the second BWP. Referring to FIG. 7, a diagram of an example of BWP switching that supports EOB mediated energy state transitioning according to one or more aspects is depicted. In the example shown in FIG. 7, a BWP switching operation 706 is performed to switch from communicating via BWP 702 (e.g., a first BWP) to communicating via BWP 704 (e.g., a second BWP). As shown in FIG. 7, BWP switching delay period 708 may occur after communicating via BWP 702 and prior to switching to communicating via BWP 704. For example, changing a BWP via which communications are performed by UE 115 may be associated with a delay period (e.g., BWP switching delay period 708). In some implementations, BWP switching delay period 708 may be a “modified BWP switching delay period” that includes such a BWP switching delay period and an offset value added to the BWP switching delay period. Additionally, as shown in FIG. 7, second BWP 704 is smaller than first BWP 702. In particular, BWP 704 is smaller in the time domain than BWP 702. Although BWP 704 is shown to be smaller in the time domain than BWP 702, in some implementations, BWP 704 may be smaller in the frequency domain than BWP 702. Additionally or alternatively, in some implementations, BWP 704 may be smaller in both the time and frequency domains than BWP 702.

Returning to FIG. 6, the timing information transmitted by base station 105 at 610 may indicate an amount of time (e.g., a duration) during which UE 115 is to communicate via the second BWP before reverting back to communicating via the first BWP (or before transitioning to communicating via a third BWP). Alternatively, the timing information may indicate a threshold number physical downlink control channel (PDCCH) monitoring occasions during which UE 115 and base station 105 are to communicate via the second BWP. Base station 105 may provide the timing information to UE 115 via a radio resource control (RRC) message, a medium access control (MAC)-control element (CE), or downlink control information (DCI). For example, any one or more components of the timing information, such as the offset value associated with the modified BWP switching delay period, may be provided to UE 115 via RRC messaging, one or more MAC-CEs, or DCI.

At 612, UE 115 performs BWP switching. In particular, UE 115 transitions from an active state to a low energy state by switching from communicating via a first BWP to communicating via a second BWP. In some implementations, a size of the first BWP (e.g., a first size) is greater than a size of the second BWP (e.g., a second size). In some aspects, UE 115 the second BWP is a default BWP. For example, BWP switching configuration 409 may include an indication of a default BWP, and the default BWP may include or correspond to any one or more of μ=0, 1, 2, or 3 or any other BWP size specifically identified by BWP switching configuration 409. Alternatively, to perform a BWP switching operation. UE 115 may be configured to select a BWP having a target size from among a plurality of BWPs as the second BWP. As another example, UE 115 may be configured to tune a size of a BWP, such as by reducing the size of the BWP used to communicate with base station 105 (e.g., the untuned BWP corresponding to the first BWP and the tuned BWP corresponding to the second BWP). Illustrative examples of reducing the size of the BWP include reducing a quantity of resource blocks (RBs) in the first BWP to generate the second BWP, removing interlaced RBs from the first BWP to generate the second BWP, other size reductions, or a combination thereof.

The timing information that base station 105 provides to UE 115 at 610 may facilitate the BWP switching operation performed at 612. For example, a transition from communicating via a first BWP to communicating via a second BWP may occur based on or after expiration of a BWP switching delay period. Alternatively, the transition from communicating via the first BWP to communicating via the second BWP may occur based on or after expiration of a modified BWP switching delay period that includes a BWP switching delay period and an offset value added to the BWP switching delay period. After this transition, UE 115 may be configured to transmit information or data to base station 105 via the second BWP for a particular time period specified by the timing information. For example, UE 115 may be configured to transmit via the second BWP until a threshold number of PDCCH occasions have occurred. The threshold number of PDCCH occasions may be indicated by the timing information.

At 614, UE 115 communicates with base station 105 via the switched BWP (e.g., the second BWP). In some implementations, the second BWP supports communication of one or more of a mobility measurement signal, a control signal, a data signal, or an combination thereof. Additionally, the second BWP may support communication of one or more of a response to a wakeup signal (WUS) received from a network entity (e.g., base station 105), a control wakeup signal (C-WUS) configured to place the network entity into an active state, a scheduling request of one or more logical channel groups (LCGs), or a combination thereof. In some implementations, UE 115 may be configured to transmit data to base station 105 via the second BWP for a time period specified in the timing information, and after conclusion of the time period, UE 115 may be configured to revert to transmitting data via the first BWP or another BWP, such as a default BWP that is distinct from the first BWP and the second BWP.

In some implementations, at 616, base station 105 may send a WUS to UE 115 via the second BWP. The WUS may cause UE 115 to transition from a quiescent state associated with communicating via the second BWP to an active state associated with communicating via the first BWP. In some such implementations, at 618, UE may perform BWP switching by switching from communicating via the second BWP to communicating via the first BWP in response to receipt of the WUS. Thus, FIG. 6 describes operations performed by UE 115 and base station 105 to perform BWP switching when UE 115 is communicating in the UL.

Some similar operations may be performed when UE 115 and base station 105 are communicating in the DL. FIG. 8 is a ladder diagram illustrating an example process 800 that supports EOB mediated energy state transitioning based on BWP switching in the DL mode of operation of UE 115 according to one or more aspects. Operations performed at 802, 804, and 810-818 of process 800 are analogous to operations performed at 602, 604, and 610-618 of process 600. Process 800 also includes operations that are unique to the DL mode of operation. At 806, base station 105 sends an end of data frame to UE 115, such as end of data frame 576 of FIG. 5. End of data frame 576 includes or corresponds to a last frame of a data burst or a TX burst sent by base station 105 to UE 115. For example, end of data frame 576 corresponds to a last packet of video data that base station 105 sends to UE 115. At 808, base station 105 sends an EOB indication to UE 115, such as EOB indication 584 of FIG. 5. EOB indication 584 may indicate an end of a communicated data frame or a communication burst, such as end of data frame 576. In some implementations, EOB indication 584 may include or correspond to a zero buffer indication that is generated based on a buffer, such as a transmit (TX) buffer, becoming empty. However, in other implementations, EOB indication 584 may include or correspond to a signal dedicated to indicating that end of data frame 576 is the last frame of a data burst or TX burst. For instance, processor 552 may generate EOB indication 584 based on EOB indication information 562 and, in response to preparation, by base station 105, to transmit end of data frame 576. To elaborate, processor 552, executing one or more applications, such as a video data processing application, may determine that an end of a data frame, such as a last frame of a data burst is to be transmitted. Based on the determination that the last frame of the data burst is to be transmitted or is being transmitted, processor 552 may generate EOB indication 584 and may transmit EOB indication 584 to UE 115.

EOB indication 584, corresponding to a DL EOB indication, causes UE 115 to transition from an active state (e.g., an active operating mode) to a low energy state (e.g., a quiescent state) during a next phase of the discontinuous communication time period. The next phase of the discontinuous communication time period may be an idle or inactive phase and may last until a next frame of data, such as a next frame of video data, is ready to be transmitted by base station 105 to UE 115.

EOB mediated energy state transitioning based on BWP switching in an UL mode or a DL mode of operation, as described above with reference to FIGS. 4-8, is advantageous. When base station 105 or application 406 of UE 115 generates an EOB indication in response to transmission of end of data frames 476, 576, UE 115 is able to quickly and efficiently switch from communicating via a first BWP to communicating via a second BWP having a smaller size than the first BWP. Communicating via a smaller sized BWP generally uses fewer RF front end components or components of TX/RX chains and thus uses less energy than communicating via a larger sized BWP. Unlike in other systems in which base stations lack information as to when a data burst will end due to the variability in time of data frames of certain data types, such as video data, the disclosed techniques obviate the foregoing problem by providing an EOB indication to UE 115 to indicate that end of data frames 476, 576 are the end of a current burst, thereby facilitating rapid and efficient transition of UE 115 from an active state to a quiescent state (e.g., a low energy state). Additionally, EOB mediated energy state transitioning based on BWP switching is rapid, thereby providing UE 115 more time in the quiescent state between data frames than is possible using conventional timer-based systems. Accordingly, EOB mediated energy state transitioning based on BWP switching provides substantial energy savings as compared to conventional operating mode switching techniques.

Another example of a low energy mode supported by the devices of FIGS. 4 and 5 is an operating mode that decodes fewer UL grants. FIG. 9 is a ladder diagram illustrating an example process 900 that supports EOB mediated energy state transitioning based on refraining from decoding an UL grant according to one or more aspects. In process 900 and as explained in more detail below, UE 115 may receive an UL EOB indication from application 406 executed by processor 402 in response to transmission, by UE 115, of end of data frame 476. To elaborate, application 406, such as video processing software, may detect that UE 115 is transmitting or will transmit end of data frame 476. Accordingly, application 406 may generate the EOB indication simultaneously with transmission, by UE 115, of end of data frame 476 or prior to transmission, by UE 115, of end of data frame 476. Therefore, since UE 115 may detect the EOB indication while end of data frame 476 is transmitted or even before end of data frame 476 is transmitted, UE 115 may be configured to quickly and efficiently refrain from decoding one or more UL grants received from base station based on receipt of the UL EOB indication.

To illustrate further, operations performed at 906 and 908 are analogous to operations performed at 606 and 806 and operations performed at 608 and 808 of FIGS. 6 and 8, respectively. At 902, base station 105 may send a configuration message to UE 115, such as configuration message 470. Configuration message 470 may include one or more parameters corresponding to UL grant decoding configuration 410. For example, the one or more parameters may include a parameter indicating for UE 115 to refrain from decoding UL grants upon receipt of an UL EOB indication.

At 910, base station 105 optionally provides timing information to UE 115 to facilitate process 900. The timing information may specify a time period during which UE 115 is to refrain from decoding UL grants received from base station 105. For example, the time period may correspond to occurrence of a threshold number of PDCCH monitoring occasions. In some implementations, the threshold number of PDCCH monitoring occasions is based on an SSSG associated with communications between UE 115 and base station 105. An SSSG may indicate a search space (SS) set in which UE 115 monitors a channel, such as PDCCH. Some SS sets are associated with less frequent channel monitoring than other SS sets, and some SSSGs include SS sets that are associated with less frequent monitoring than other SSSGs. For example, a 5G NR wireless communication system might typically support three SSSGs, denoted SSSG #0,SSSG #1,and SSSG #2,although more or fewer SSSGs are possible. Each of SSSG #0,SSSG #1,and SSSG #2 may differ from one another in SS sets included in or associated with each of the SSSGs. For instance, SSSG #0 might include a first SS set associated with more frequent channel monitoring, such as monitoring of PDCCH, than a second SS set associated with or included in SSSG #1 and SSSG #2.Accordingly, the timing information may indicate, to UE 115, an SSSG (e.g., one of SSSG #0,SSSG #1,or SSSG #2) that is associated with the threshold number of PDCCH monitoring occasions during which UE 115 is to refrain from decoding UL grants. Alternatively, the time period may be indicated in other ways, such as a particular duration, or occurrence of one or more other trigger conditions. In some implementations, base station 105 may provide the timing information to UE 115 via a RRC message, a MAC-CE, or DCI. Alternatively, in some implementations, base station 105 may provide the timing information to UE 115 as part of configuration message 470.

At 912, UE 115 refrains from decoding one or more UL grants for the time period in response to detection, by UE 115, of an EOB indication. In some implementations, UE 115 refrains from decoding the one or more UL grants for a period of time identified in the timing information. For example, UE 115 may configure a timer to measure passage of the time period. Alternatively, UE 115 may monitor for and track occurrence of one or more trigger conditions, such as PDCCH monitoring occasions. Upon expiration of the time period identified in the timing information, UE 115 may resume decoding UL grants received from base station 105.

EOB mediated energy state transitioning based on refraining from decoding UL grants, as described in FIG. 9, provides various advantages, such as rapid and efficient transition by UE 115 from an active state to a low energy state. To illustrate, when UE 115 receives an EOB indication (e.g., based on transmission of an end of data frame), UE 115 transitions to a quiescent state in which it refrains from decoding one or more UL grants received from base station 105. Refraining from decoding the one or more UL grants reduces power consumption at UE 115 as compared to the active state. Unlike in other systems in which base stations lack information as to when a data burst will end due to the variability in time of data frames of certain data types, such as video data, the disclosed techniques obviate the foregoing problem by providing an EOB indication to UE 115 to indicate that end of data frame 476 is at the end of a current burst, thereby facilitating rapid and efficient transition of UE 115 from an active state to a quiescent state (e.g., a low energy state). Additionally, EOB mediated energy state transitioning based on refraining, by UE 115, from decoding one or more UL grants is rapid, thereby providing UE 115 more time in the quiescent state between data frames than is possible using conventional timer-based systems. Accordingly, EOB mediated energy state transitioning based on refraining, by UE 115, from decoding one or more UL grants provides substantial energy savings as compared to conventional operating mode switching techniques.

FIG. 10 is a ladder diagram illustrating an example process 1000 that supports EOB mediated energy state transitioning based on monitoring for scheduling downlink control (DCI) and not for other DCI according to one or more aspects. At 1002, base station 105 may send configuration message 570 to UE 115. Configuration message 570 may include DCI monitoring configuration 512 that includes one or more parameters to cause processor 502 of UE to implement process 1000. The one or more parameters may include a time period during which UE 115 is to monitor for scheduling DCI and not for other DCI or other information associated with initiating process 1000.

Operations performed at 1004 and 1008 are analogous to operations performed at 806, 808 of FIG. 8. At 1010, base station 105 may provide timing information to UE 115. Operations performed at 1010 are analogous to operations performed at 610, 810, and 910 of FIGS. 6-9, except that the time periods include or correspond to a period of time during which UE 115 is configured to monitor for scheduling DCI and not for other DCI. After expiration of the time period indicated by the timing information, UE 115 may resume monitoring for scheduling DCI and non-scheduling DCI. While FIG. 10 depicts that base station 105 provides timing information to UE 115 separately from configuration message 570, in some implementations, base station 105 may provide the timing information in configuration message 570.

At 1012, UE 115 monitors for scheduling DCI and not for other DCI, such as non-scheduling DCI. By monitoring for scheduling DCI and not for other DCI, UE 115 may reduce a frequency with which UE 115 monitors PDCCH with resulting energy savings. UE 115 may monitor for scheduling DCI and not for other DCI during a time period specified in the timing information. In some implementations, after conclusion of the time period specified in the timing information, UE 115 may resume monitoring for all DCI.

EOB mediated energy state transitioning based on monitoring, by UE 115, for scheduling DCI and not for other DCI, as described in FIG. 10, provides various advantages, such as rapid and efficient transition by UE 115 from an active state to a low energy state. To illustrate, when UE 115 receives EOB indication 584 (e.g., based on transmission of an end of data frame), UE 115 transitions to a quiescent state in which UE 115 monitors for scheduling DCI and not for other DCI. Monitoring, by UE 115, for scheduling DCI and not for other DCI reduces power consumption at UE 115 as compared to the active state.

Unlike in other systems in which base stations lack information as to when a data burst will end due to the variability in time of data frames of certain data types, such as video data, the disclosed techniques obviate the foregoing problem by providing EOB indication 584 to UE 115 to indicate that end of data frame 576 is at the end of a current burst, thereby facilitating rapid and efficient transition of UE 115 from an active state to a quiescent state (e.g., a low energy state). Additionally, EOB mediated energy state transitioning based on monitoring, by UE 115, for scheduling DCI and not for other DCI is rapid, thereby providing UE 115 more time in the quiescent state between data frames than is possible using conventional timer-based systems. Accordingly, EOB mediated energy state transitioning based monitoring, by UE 115, for scheduling DCI and not for other DCI provides substantial energy savings as compared to conventional operating mode switching techniques.

FIG. 11 is a ladder diagram illustrating an example process 1100 that supports EOB mediated energy state transitioning based on switching communication or monitoring according to SSSGs in an UL mode of operation of UE 115 according to one or more aspects. At 1102, base station 105 may send configuration message 470 to UE 115. Configuration message 470 may include SSSG configuration 414 that includes one or more parameters to cause processor 402 of UE 115 to implement process 1100. The one or more parameters may include identification of one or more SSSGs (e.g., SSSG #0-#2) such that UE 115 may transition from the active state to the low energy state and then communicate or monitor according to one or more of the switched SSSGs in response to detection, by UE 115, of the EOB indication. Additionally or alternatively, the one or more parameters may include timing information, such as explained more fully with reference to step 1110 below. In some implementations, configuration message 470 may include or correspond to DCI, MAC-CE, or RRC.

Operations performed at 1106 and 1108 are analogous to operations performed at 606 and 608 of FIGS. 6 and 906 and 908 of FIG. 9. Operations performed at 1110 are analogous to operations performed at 610 and 910 of FIGS. 6 and 9, except that, at 1110, base station 105 may provide timing information to UE 115 that identifies an amount of time during which UE 115 communicates according to a second SSSG after switching from the first SSSG to the second SSSG. Stated another way, UE 115 may be configured to switch from communicating according to the first SSSG to communicating according to the second SSSG. Additionally, the timing information may indicate, to UE 115, a time period that elapses between a first instance of time at which UE 115 operates in a first SSSG (e.g., one of SSSG #0-#2) and a second instance of time at which UE operates in as second SSSG. In some implementations, the timing information may include or correspond to a number of PDCCH monitoring occasions associated with one or more SSSGs.

At 1112, UE 115 switches from communicating or monitoring (e.g., for PDCCH) according to a first SSSG to communicating or monitoring (e.g., for PDCCH) according to a second SSSG. For example, in response to detecting the EOB associated with transmission, by UE 115, of end of data frame 476 to base station 105, UE 115 is configured to transition from an active state at UE 115 to a low energy state at UE 115 by switching from performing a communication or monitoring operation according to the first SSSG (e.g., associated with more frequent PDCCH monitoring) to performing a communication or monitoring operation according to the second SSSG (e.g., associated with less frequent PDCCH monitoring relative to the first SSSG). To elaborate, application 406, such as video processing software, may detect that UE 115 is transmitting or will transmit end of data frame 476. Accordingly, application 406 may generate the EOB indication simultaneously with transmission, by UE 115, of end of data frame 476 or prior to transmission, by UE 115, of end of data frame 476. Therefore, since UE 115 may detect the EOB indication while end of data frame 476 is transmitted or even before end of data frame 476 is transmitted, UE 115 may be configured to quickly and efficiently transition from the active state to the quiescent state by switching from performing a communication or monitoring operation according to the first SSSG (e.g., a more energy intensive SSSG involving more frequent monitoring for PDCCH) to performing a communication or monitoring operating according to the second SSSG (e.g., a less energy intensive SSSG involving less frequent monitoring for PDCCH relative to the first SSSG).

The first SSSG may be associated with a first quantity of PDCCH monitoring occasions, and the second SSSG may be associated with a second quantity of PDCCH monitoring occasions that is less frequent than the first quantity. Accordingly, when UE 115 switches to performing a communication or monitoring operation according to the second SSSG, UE 115 may expend less energy than when UE 115 operates in the first SSSG, at least because UE 115 may perform fewer PDCCH monitoring operations when operating in the second SSSG than when operating in the first SSSG.

FIG. 12 is a ladder diagram illustrating an example process 1200 that supports EOB mediated energy state transitioning based on SSSG switching in an DL mode of operation of UE 115 according to one or more aspects. Process 1200 is analogous to process 1100 except that process 1200 describes a DL mode of operation of UE 115, while process 1100 describes an UL mode of operation of UE 115. Accordingly, unlike in process 1100, in process 1200, base station 105 sends end of data frame 576 and EOB indication 584 to UE 115.

EOB mediated energy state transitioning based on switching, by UE 115, from performing a communication or monitoring operation according to a first SSSG to performing a communication or monitoring operation according to a second SSSG, as described in FIGS. 11 and 12, provides various advantages, such as rapid and efficient transition by UE 115 from an active state to a low energy state. To illustrate, when UE 115 detects an EOB indication or receives EOB indication 584 (e.g., based on transmission of an end of data frame), UE 115 transitions to a quiescent state in which UE 115 performs communication or monitoring operations according to a second SSSG rather than according to the first SSSG associated with the active state. To elaborate, in the active state, UE 115 may perform communication or monitoring operations (e.g., monitoring for PDCCH) according to the first SSSG. In response to detecting the EOB indication, UE 115 may perform communication or monitoring operations (e.g., monitoring for PDCCH) according to the second SSSG. Since the number of monitoring occasions (e.g., PDCCH monitoring occasions) in the second SSSG is less than the number of monitoring occasions (e.g., PDCCH monitoring occasions) in the first SSSG, UE 115 conserves energy by switching communication or monitoring operations to the second SSSG. Unlike in other systems in which base stations lack information as to when a data burst will end due to the variability in time of data frames of certain data types, such as video data, the disclosed techniques obviate the foregoing problem by providing the EOB indication or EOB indication 584 to UE 115 to indicate that end of data frame 476, 576 is at the end of a current burst, thereby facilitating rapid and efficient transition of UE 115 from an active state to a quiescent state (e.g., a low energy state). Additionally, EOB mediated energy state transitioning based on switching, by UE 115, from the first SSSG to the second SSSG, thereby provides UE 115 more time in the quiescent state between data frames than is possible using conventional timer-based systems. Accordingly, EOB mediated energy state transitioning based on switching, by UE 115, from the first SSSG to the second SSSG provides substantial energy savings as compared to conventional operating mode switching techniques.

FIG. 13 is a flow diagram illustrating an example process 1300 that supports EOB mediated energy state transitioning according to one or more aspects. Operations of process 1300 may be performed by a UE, such as UE 115 described above with reference to FIGS. 1-6 and 8-12 or a UE described with reference to FIG. 14. Example operations (also referred to as “blocks”) of process 1300 may enable UE 115 to support EOB mediated energy state transitioning.

In block 1302, the UE detects an EOB indication. The EOB indication indicates an end of a communicated data frame. For example, the EOB indication may include or correspond to EOB indication 584 of FIG. 5. The EOB indication 584 may indicate an end of a communicated data frame, such as end of data frame 476, 576.

In block 1304, in response to detection of the EOB indication, the UE transitions from an active state of the UE to a low energy state of the UE during a next phase of discontinuous communication. For example, in response to detection of the EOB indication 584, UE 115 may transition from an active state (e.g., a high energy state of the UE) to a low energy state (e.g., a quiescent state) during a next phase of discontinuous communication, such as a next DTX phase or a next DRX phase.

In some implementations, detection of the EOB indication includes the UE receiving an UL EOB indication from an application executed at the UE. For example, application may include or correspond to application 406 of FIG. 4. To illustrate, in response to transmission of end of data frame 476, UE 115 may receive an UL EOB indication from application 406 executed at UE 115. Additionally or alternatively, UE 115 may detect the EOB indication during a discontinuous communication active phase of UE 115, and the discontinuous communication active phase may include a DTX active phase (e.g., if UE 115 operates in an UL mode of operation). Alternatively, the discontinuous communication active phase may include a DRX active phase (e.g., if UE 115 operates in a DL mode of operation).

In some implementations, detection of the EOB indication includes the UE receiving a DL EOB indication from a network entity. For example, UE 115 may receive EOB indication 584 from base station 105. To illustrate, base station 105 may transmit end of data frame 576 and EOB indication 578/580. In some implementations, base station 105 may transmit end of data frame 576 and EOB indication 578/580 concurrently, while in other implementations, base station 105 may transmit EOB indication 578/580 after transmitting end of data frame 576.

In some implementations, to transition from the active state to the low energy state, the UE performs BWP switching from a first BWP to a second BWP. For example, UE 115 may perform BWP switching as described with reference to FIGS. 4-6 and 8. In some implementations, a first size of the first BWP is greater than a second size of the second BWP. In some such implementations, to perform BWP switching from the first BWP to the second BWP, the UE switches to a default BWP as the second BWP. For example, and as explained with reference to FIGS. 6 and 8, UE 115 may switch from communicating via a first BWP to communicating via a default BWP that corresponds to the second BWP. The default BWP may be smaller than the first BWP. Alternatively, to perform BWP switching from the first BWP to the second BWP, the UE may select, based on a BWP size, the second BWP from among a plurality of BWPs. For example, UE 115 may select, based on a target BWP size, the second BWP having the target BWP size from among a plurality of BWPs, such as BWP sizes μ=0, 1, 2, or 3 as explained with reference to FIG. 6.

In some implementations in which BWP switching is performed, during the next phase of discontinuous communication, the UE transmits data to a network entity via the second BWP. For example, UE 115 may transmit data to base station 105 via the second BWP. Moreover, in some implementations, the EOB indication is detected during a discontinuous active phase of the UE. For instance, UE 115 may detect the EOB indication or EOB indication 584 during a discontinuous active phase of UE 115. Additionally or alternatively, to perform the BWP switching from the first BWP to the second BWP, the UE may transition from the first BWP to the second BWP based on expiration of a BWP switching delay period. For example, UE 115 may transition from communicating via the first BWP to communicating via the second BWP based on expiration of BWP switching delay period 708. Alternatively, to perform the BWP switching from the first BWP to the second BWP, the UE may transition from communicating via the first BWP to communicating via the second BWP based on expiration of a modified BWP switching delay period. For instance, UE 115 may transition from communicating via the first BWP to communicating via the second BWP after expiration of a time period that corresponds to an altered or modified version of BWP switching delay period 708. In some such implementations, the modified BWP switching delay period includes a BWP switching delay period and an offset value added to the BWP switching delay period. In some such implementations, the offset value is specified in a RRC message, a MAC-CE, or a DCI. For example, configuration messages 470, 570 may include the offset value, and configuration messages 470, 570 may be RRC messages, MAC-CEs, or DCI.

In some implementations in which BWP switching is performed, the second BWP is operable to transmit any one or more of a mobility measurement signal, a control signal, a data signal, a response to a WUS received from a network entity, a C-WUS configured to place the network entity into an active state, and a scheduling request of one or more LCGs. For example, when UE 115 transmits via the second BWP, UE may transmit any of the foregoing types of signals, messages, or data via the second BWP. Additionally or alternatively, to perform BWP switching from the first BWP to the second BWP, the UE may reduce a quantity of RBs in the first BWP to generate the second BWP, remove interlaced RBs from the first BWP to generate the second BWP, or a combination thereof. For example, in performing the BWP switching operation to communicate via a second, smaller BWP from the first BWP, RBs or interlaced RBs may be removed from the first BWP.

In some implementations, the UE receives an indication from the network entity. For example, UE 115 may receive confirmation indication 474 or confirmation indication 574 from base station 105. In some such implementations, the indication is in addition to the EOB indication. For instance, confirmation indication 474 or confirmation indication 574 is in addition to EOB indication 578/580. Additionally or alternatively, the indication may be received after occurrence of a threshold number of PDCCH monitoring occasions or within a particular time period. For instance, UE 115 may receive confirmation indication 474 or confirmation indication 574 after occurrence of the threshold number of PDCCH monitoring occasions or within a particular time period, such as a time period identified by timing information provided by base station 105 to UE 115. In some such implementations, at least a portion of the particular time period corresponds to a BWP switching delay. For example, the portion of the particular time period may correspond to BWP switching delay period 708. Additionally or alternatively, the UE may receive DCI that includes the indication. For instance, UE 115 may receive DCI that includes confirmation indication 474 or confirmation indication 574. The DCI may be a non-scheduling DCI.

In some implementations, the UE receives a configuration message from a base station. For example, UE 115 receives configuration messages 470, 570 from base station 105. In some implementations, the configuration message includes one or more parameters associated with performing the BWP switching from the first BWP to the second BWP. For instance, configuration message 470, 570 may include one or more parameters associated with performing the BWP switching from the first BWP to the second BWP.

These one or more parameters may include an indication of a BWP selection, such as BWPs from which UE 115 may select to switch to the second BWP. Additionally or alternatively, the configuration message may be received during a RRC procedure. For instance, UE 115 may receive configuration messages 470, 570 while performing a RRC procedure with base station 105. Additionally or alternatively, the one or more parameters may include an indication of the size of the second BWP, a first time period that transpires from operating in the first BWP to operating in the second BWP, a duration of a second time period to operate in the second BWP, or a combination thereof. In some such implementations, the first time period includes a BWP switching delay period, a modified BWP switching delay period, a threshold number of PDCCH monitoring occasions, or a combination thereof. For instance, the time period may include or correspond to BWP switching delay period 708.

In some implementations, the UE sends, to a network entity, a BWP switching preference indication. The BWP switching preference indication indicates a BWP switching preference, an expected occurrence time of the next phase of discontinuous communication, or a combination thereof. For example, UE 115 may send confirmation indications 474, 574 to base station 105. Confirmation indications 474, 574 may indicate preferences of UE 115 for performing a BWP switching operation, such as the BWP switching preference (e.g., a preferred BWP switching mechanism), the expected occurrence time of the next phase of discontinuous communication, or a combination thereof. In some implementations, confirmation indication 474, 574 includes an identification of the second BWP, a size of the second BWP, a time period during which to operate in the second BWP, or a combination thereof.

In some implementations, detection of the EOB indication includes the UE receiving an UL EOB indication from an application executed at the UE. For example, UE 115 may receive an UL indication from application 406 executed by processor 402. In some implementations, the UE, when in the low energy state, refrains from decoding an UL grant. For example and as explained with reference to FIG. 9, UE 115 may transition, from an active state (e.g., a high energy state) to a low energy state (e.g., a quiescent state) in which UE 115 refrains from decoding UL grants from base station 105. In some such implementations, the UE refrains from decoding the UL grant by refraining from decoding the UL grant during a particular time period that corresponds to occurrence of a threshold number of PDCCH monitoring occasions. For instance, UE 115 may receive timing information from base station 105 that indicates the threshold number of PDCCH monitoring occasions. Additionally or alternatively, UE 115 may receive the indication of the threshold number of PDCCH monitoring occasions in configuration message 470. Additionally or alternatively, the particular time period may be indicated by a RRC message, a MAC-CE, or a DCI. For example, configuration message 470, containing an indication of the particular time period, may include or correspond to an RRC message, a MAC-CE, or DCI. Additionally or alternatively, the threshold number of PDCCH monitoring occasions may be based on a SSSG. For example, configuration message 470 may indicate a SSSG, and the SSSG may be associated with the threshold number of PDCCH monitoring occasions.

In some implementations, detection of the EOB indication includes the UE receiving a DL EOB indication from a network entity. For example, UE 115 receives EOB indication 578/580 from base station 105. In some such implementations, when in the low energy state, the UE monitors for scheduling DCI and not for other DCI. For example, UE 115 may transition from an active state to a low energy state in which UE 115 monitors for scheduling DCI and not for other DCI, such as non-scheduling DCI. In some such implementations, to monitor for scheduling DCI and not for other DCI, the UE monitors for the scheduling DCI with a first periodicity that is longer than a second periodicity with which the UE monitored for the scheduling DCI prior to receiving the DL EOB indication. For example, UE 115 may monitor for the scheduling DCI less frequently after receiving EOB indication 578/580 than UE 115 monitored for the scheduling DCI prior to receiving EOB indication 570/580. Additionally or alternatively, to monitor for the scheduling DCI and not for other DCI, the UE may monitor for the scheduling DCI during a time period indicated by a RRC message, a MAC-CE, or DCI. For example, UE 115 may receive configuration message 570 from base station 105 that indicates a time period during which UE 115 is to monitor for scheduling DCI and not for non-scheduling DCI. Configuration message 570 may include or correspond to an RRC message, a MAC-CE, or DCI. Alternatively, UE 115 may receive timing information from base station 105 (i.e., separately from configuration message 570), which indicates a time period during which UE 115 is to monitor for scheduling DCI and not for other DCI. The timing information may be received in a RRC message, a MAC-CE, or DCI.

In some implementations in which the UE monitors for scheduling DCI and not for other DCI, the scheduling DCI includes an indication to switch from a first search SSSG to a second SSSG. For example, the scheduling DCI for which UE 115 monitors may include an indication that causes UE 115 to switch from the first SSSG to the second SSSG. In some such implementations, the UE monitors for the scheduling DCI and not for the other DCI in a first SSSG that is less dense than a second SSSG corresponding to the active state. For example, UE 115 may monitor for scheduling DCI and not for other DCI, such as non-scheduling DCI, in a first SSSG that is less dense (e.g., includes or requires fewer PDCCH monitoring occasions) than the second SSSG.

In some implementations, to transition from the active state at the UE to the low energy state at the UE, the UE switches from communicating according to a first SSSG to communicating according to a second SSSG. For example, UE 115 may switch from monitoring for signals in a first SSSG to monitoring for signals in a second SSG in response to detection of an EOB indication. In some implementations, the first SSSG is associated with a first quantity of PDCCH monitoring occasions, and the second SSSG is associated with a second quantity of PDCCH monitoring occasions that is less than the first quantity (e.g., the second SSSG is less dense than the first SSSG). In some such implementations, the first SSSG and the second SSSG are indicated by DCI, a MAC-CE, or a RRC message. For example, configuration messages 470, 570 may indicate the first SSSG and the second SSSG, and configuration messages 470, 570 may include or correspond to DCI, a MAC-CE, or a RRC message. Additionally or alternatively, to switch from the first SSSG to the second SSSG, the UE transitions from the first SSSG to the second SSSG based on expiration of a particular time period corresponding to a quantity of PDCCH monitoring occasions associated with the first SSSG. In some implementations, the particular time period is indicated by DCI, a MAC-CE, or a RRC message. For example, configuration messages 470, 570 may indicate the quantity of PDCCH monitoring occasions.

In some implementations, the EOB indication includes a zero buffer indication. For example, EOB indication 578/580 may include or correspond to the zero buffer indication. Additionally or alternatively, the data may include one or more bursts of video data packets. For example, the data corresponding to end of data frames 476, 576 may be video data.

FIG. 14 is a block diagram of an example UE 1400 that supports EOB mediated energy state transitioning according to one or more aspects. UE 1400 may be configured to perform operations, including the blocks of a process described with reference to FIG. 13. In some implementations, UE 1400 includes the structure, hardware, and components shown and described with reference to UE 115 of FIGS. 1-6 and 8-13. For example, UE 1400 includes controller 280, which operates to execute logic or computer instructions stored in memory 282, as well as controlling the components of UE 1400 that provide the features and functionality of UE 1400. UE 1400, under control of controller 280, transmits and receives signals via wireless radios 1401a-r and antennas 252a-r. Wireless radios 1401a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include application 1406, EOB indicator information 1408, BWP switching configuration 1409, UL grant decoding configuration 1410, DCI monitoring configuration 1412, SSSG configuration 1414, and communication logic 1420. Application 1406, EOB indicator information 1408, BWP switching configuration 1409, UL grant decoding configuration 1410, DCI monitoring configuration 1412, SSSG configuration 1414, and communication logic 1420 may each, respectively, correspond to application 406, 506, EOB indication information 408, 508, BWP switching configuration 409, 509, DCI monitoring configuration 412, 512, and SSSG configuration 414, 514 of FIGS. 4 and 5. Communication logic 1420 may be configured to enable communication between UE 1400 and one or more other devices. UE 1400 may receive signals from or transmit signals to one or more network entities, such as base station 105 of FIGS. 1-5 and or a base station as illustrated in FIG. 16.

FIG. 15 is a flow diagram illustrating an example process 1500 that supports EOB mediated energy state transitioning according to one or more aspects. Operations of process 1500 may be performed by a base, such as base station 105 described above with reference to FIGS. 1-6 and 8-12 or a base station described with reference to FIG. 16. Example operations (also referred to as “blocks”) of process 1500 may enable base station 105 to support EOB mediated energy state transitioning.

At 1502, the base station detects an end of a data frame. The end of the data frame may correspond to end of data frame 576 (e.g., a last frame of a data burst). For instance, end of data frame 576 may correspond to a last frame of data, such as video data, that base station 105 transmits to UE 115. In some implementations, software, executed by processor 552 of base station 105, may identify or detect that the last frame of a data burst is ready to be transmitted or has been transmitted.

At 1504, the base station transmits an EOB indication in response to detection of the end of data frame. For example, base station 105 may transmit, to UE 115, EOB indication 584 in response to detecting end of data frame 576. In some implementations, base station 105 may transmit EOB indication 584 concurrent with end of data frame 576, while in other implementations base station 105 may transmit EOB indication 584 prior to transmission of end of data frame 576 or after transmission of end of data frame 576. To elaborate, software, executed by processor 552 of base station 105, may be configured to identify or predict that base station 105 is preparing to transmit end of data frame 576. Based on detecting that base station 105 is preparing to transmit end of data frame 576, base station 105 may generate and transmit EOB indication 584.

FIG. 16 is a block diagram of an example base station 1600 that supports EOB mediated energy state transitioning according to one or more aspects. Base station 1600 may be configured to perform operations, including the blocks of process 1500 described with reference to FIG. 15. In some implementations, base station 1600 includes the structure, hardware, and components shown and described with reference to base station 105 of FIGS. 1-4 and 6. For example, base station 1600 may include controller 240, which operates to execute logic or computer instructions stored in memory 242, as well as controlling the components of base station 1600 that provide the features and functionality of base station 1600. Base station 1600, under control of controller 240, transmits and receives signals via wireless radios 1601a-t and antennas 234a-t. Wireless radios 1601a-t include various components and hardware, as illustrated in FIG. 2 for base station 105, including modulator and demodulators 232a-t, transmit processor 220, TX MIMO processor 230, MIMO detector 236, and receive processor 238.

As shown, memory 242 may include EOB indication information 1602, which may correspond to EOB indication information 462, 562. Communication logic 1603 may be configured to enable communication between base station 1600 and one or more other devices. Base station 1600 may receive signals from or transmit signals to one or more UEs, such as UE 115 of FIGS. 1-6 and 10-12 or UE 1400 of FIG. 14.

It is noted that one or more blocks (or operations) described with reference to FIGS. 13 and 15 may be combined with one or more blocks (or operations) described with reference to another of the figures. For example, one or more blocks (or operations) of FIG. 13 may be combined with one or more blocks (or operations) of FIG. 15. As another example, one or more blocks associated with FIG. 13 may be combined with one or more blocks or operations associated with FIGS. 6-12. As another example, one or more blocks associated with FIG. 15 may be combined with one or more blocks (or operations) associated with FIGS. 6-12. Additionally, or alternatively, one or more operations described above with reference to FIGS. 6-12 may be combined with one another. For instance, EOB mediated energy state transitioning based on BWP switching may be combined with EOB mediated energy state transitioning based on refraining from decoding an UL grant, based on monitoring scheduling DCI and not other DCI, based on switching SSSGs, or any combination thereof, and vice versa.

In one or more aspects, techniques for supporting (EOB) mediated energy state transitioning may include additional aspects, such as any single aspect or any combination of aspects described below or in connection with one or more other processes or devices described elsewhere herein. In a first aspect, techniques for supporting EOB mediated energy state transitioning may include detecting an EOB indication, the EOB indication indicating an end of a communicated data frame. The techniques may further include, in response to detecting the EOB indication, transitioning from an active state at the UE to a low energy state at the UE during a next phase of discontinuous communication. In some examples, the techniques of the first aspect may be implemented in a method or process. In some other examples, the techniques of the first aspect may be implemented in a wireless communication device, which may include a network entity or a component of a network entity, a UE or a component of a UE, a base station or a component of a base station, or any combination thereof. For example, the techniques may include or correspond to a method of wireless communication performed by a UE. In some examples, the wireless communication device may include at least one processing unit or system (which may include an application processor, a modem or other components) and at least one memory device coupled to the processing unit or system. The processing unit may be configured to perform operations described herein with respect to the wireless communication device. In some examples, the memory device includes a non-transitory computer-readable medium storing instructions (e.g., having program code stored thereon) that, when executed by the processing unit, are configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a second aspect, in combination with the first aspect, data associated with the communicated data frame includes one or more bursts of video data packets.

In a third aspect, in combination with the first aspect or the second aspect, transitioning from the active state to the low energy state includes performing bandwidth part (BWP) switching from a first BWP to a second BWP.

In a fourth aspect, in combination with the third aspect, a first size of the first BWP is greater than a second size of the second BWP.

In a fifth aspect, in combination with one or more of the first aspect through the fourth aspect, detecting the EOB indication includes receiving an uplink (UL) EOB indication from an application executed at the UE or a zero buffer indication.

In a sixth aspect, in combination with one or more of the first aspect through the fourth aspect, detecting the EOB indication includes receiving a downlink (DL) EOB indication from a network entity.

In an seventh aspect, in combination with one or more of the fourth aspect through the sixth aspect, performing the BWP switching from the first BWP to the second BWP includes switching to a default BWP as the second BWP.

In an eighth aspect, in combination with one or more of the fourth aspect through the sixth aspect, performing the BWP switching from the first BWP to the second BWP includes selecting, based on a BWP size, the second BWP from among a plurality of BWPs.

In a ninth aspect, in combination with one or more of the fourth aspect through the eighth aspect, detecting the EOB indication includes detecting the EOB indication during a discontinuous communication active phase of the UE.

In a tenth aspect, in combination with the ninth aspect, the technique further includes during the next phase of discontinuous communication, transmitting data to a network entity via the second BWP.

In an eleventh aspect, in combination with one or more of the fourth aspect through the tenth aspect, performing the BWP switching from the first BWP to the second BWP includes transitioning from the first BWP to the second BWP based on expiration of a BWP switching delay period.

In a twelfth aspect, in combination with one or more of the fourth aspect through the tenth aspect, performing the BWP switching from the first BWP to the second BWP includes transitioning from the first BWP to the second BWP based on expiration of a modified BWP switching delay period.

In a thirteenth aspect, in combination with the twelfth aspect, the modified BWP switching delay period includes a BWP switching delay period and an offset value added to the BWP switching delay period.

In a fourteenth aspect, in combination with the thirteenth aspect, the offset value is specified in a radio resource control (RRC) message, a medium access control (MAC)-control element (CE), or a downlink control information (DCI).

In a fifteenth aspect, in combination with one or more of the fourth aspect through the fourteenth aspect, the second BWP is operable to transmit any one or more of: a mobility measurement signal, a control signal, a data signal, a response to a wakeup signal (WUS) received from a network entity, a control wakeup signal (C-WUS) configured to place the network entity into an active state, and a scheduling request of one or more logical channel groups (LCGs).

In a sixteenth aspect, in combination with one or more of the fourth aspect through the fifteenth aspect, the technique further includes receiving, at the UE, an indication from a network entity, the indication indicating to perform BWP switching from the first BWP to the second BWP.

In an seventeenth aspect, in combination with the sixteenth aspect, the indication is in addition to the EOB indication, the indication is received after occurrence of a threshold number of physical downlink control channel (PDCCH) monitoring occasions or within a particular time period, at least a portion of the particular time period corresponds to a BWP switching delay, and the BWP switching from the first BWP to the second BWP is performed in response to receiving the indication after the occurrence of the threshold number of PDCCH monitoring occasions or within the particular time period.

In an eighteenth aspect, in combination with the seventeenth aspect, the technique further includes receiving downlink control information (DCI) that includes the indication, where the DCI is a non-scheduling DCI.

In a nineteenth aspect, in combination with one or more of the fourth aspect through the eighteenth aspect, performing the BWP switching from the first BWP to the second BWP includes reducing a quantity of resource blocks (RBs) in the first BWP to generate the second BWP, removing interlaced RBs from the first BWP to generate the second BWP, or a combination thereof.

In a twentieth aspect, in combination with one or more of the fourth aspect through the nineteenth aspect, the technique further includes receiving a configuration message from a base station.

In a twenty first aspect, in combination with the twentieth aspect, the configuration message includes one or more parameters associated with performing the BWP switching from the first BWP to the second BWP.

In a twenty second aspect, in combination with the twentieth aspect or the twenty first aspect, the configuration message is received during a radio resource control (RRC) procedure.

In a twenty third aspect, in combination with one or more of the twenty first aspect or the twenty second aspect, the one or more parameters indicate a size of the second BWP, a first time period that transpires from communicating via the first BWP to communicating via the second BWP, a duration of a second time period to communicate via the second BWP, or a combination thereof.

In a twenty fourth aspect, in combination with the twenty third aspect, the first time period includes a BWP switching delay period, a modified BWP switching delay period, a threshold number of physical downlink control channel (PDCCH) monitoring occasions, or a combination thereof.

In a twenty fifth aspect, in combination with one or more of the fourth aspect through the nineteenth aspect, the technique further includes sending, to a network entity, a BWP switching preference indication, the BWP switching preference indication indicating a BWP switching preference, an expected occurrence time of the next phase of discontinuous communication, or a combination thereof.

In a twenty sixth aspect, in combination with the twenty fifth aspect, the BWP switching preference includes: an identification of the second BWP, a size of the second BWP, a time period during which to communicate via the second BWP, or a combination thereof.

In a twenty seventh aspect, in combination with the first aspect, transitioning from the active state to the low energy state includes switching from communicating according to a first search space set group (SSSG) to communicating according to a second SSSG.

In a twenty eighth aspect, in combination with the first aspect or the twenty seventh aspect, the first SSSG is associated with a first quantity of physical downlink control channel (PDCCH) monitoring occasions.

In a twenty ninth aspect, in combination with the twenty eighth aspect, the second SSSG is associated with a second quantity of PDCCH monitoring occasions that is less than the first quantity.

In a thirtieth aspect, in combination with one or more of the twenty seventh aspect through the twenty ninth aspect, the first SSSG and the second SSSG are indicated by downlink control information (DCI), a medium access control (MAC)-control element (CE), or a radio resource control (RRC) message.

In a thirty first aspect, in combination with one or more of the twenty seventh aspect through the thirtieth aspect, switching from the first SSSG to the second SSSG includes transitioning from the first SSSG to the second SSSG based on expiration of a particular time period corresponding to a quantity of physical downlink control channel (PDCCH) monitoring occasions associated with the first SSSG.

In a thirty second aspect, in combination with the thirty first aspect, the particular time period is indicated by another DCI, another MAC-CE, or another RRC message.

In a thirty third aspect, in combination with the first aspect, detecting the EOB indication includes receiving an uplink (UL) EOB indication from an application.

In a thirty fourth aspect, in combination with the thirty third aspect, the technique further includes refraining from decoding an UL grant when in the low energy state.

In a thirty fifth aspect, in combination with the thirty fourth aspect, refraining from decoding the UL grant includes refraining from decoding the UL grant during a particular time period that corresponds to occurrence of a threshold number of physical downlink control channel (PDCCH) monitoring occasions.

In a thirty sixth aspect, in combination with the thirty fifth aspect, the particular time period is indicated by a radio resource control (RRC) message, a medium access control (MAC)-control element (CE), or a downlink control information (DCI).

In a thirty seventh aspect, in combination with the thirty sixth aspect, the threshold number of PDCCH monitoring occasions is based on a search space set group (SSSG).

In a thirty eighth aspect, in combination with the first aspect, detecting an EOB indication includes receiving a downlink (DL) EOB indication from a network entity.

In a thirty ninth aspect, in combination with the first aspect or the thirty eighth aspect, the technique further includes monitoring for scheduling downlink control information (DCI) and not for other DCI when in the low energy state.

In a fortieth aspect, in combination with the thirty ninth aspect, monitoring for the scheduling DCI and not for the other DCI includes monitoring for the scheduling DCI with a first periodicity that is longer than a second periodicity with which monitoring was performed for the scheduling DCI prior to receiving the DL EOB indication.

In a forty first aspect, in combination with the thirty ninth aspect, monitoring for the scheduling DCI and not for the other DCI includes monitoring for the scheduling DCI during a time period indicated by a radio resource control (RRC) message, a medium access control (MAC)-control element (CE), or a DCI.

In a forty second aspect, in combination with the forty first aspect, the scheduling DCI includes an indication to switch from a first search space set group (SSSG) to a second SSSG.

In a forty third aspect, in combination with the thirty ninth aspect, monitoring for the scheduling DCI and not for the other DCI includes monitoring for the scheduling DCI in a first search space set group (SSSG) that is less dense than a second SSSG corresponding to the active state.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-16 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a user equipment (UE), the method comprising:
detecting an end of burst (EOB) indication, the EOB indication indicating an end of a communicated data frame; and
in response to detecting the EOB indication, transitioning from an active state at the UE to a low energy state at the UE during a next phase of discontinuous communication.

2. The method of claim 1, wherein:
data associated with the communicated data frame includes one or more bursts of video data packets, and
transitioning from the active state to the low energy state includes performing bandwidth part (BWP) switching from a first BWP to a second BWP, and wherein a first size of the first BWP is greater than a second size of the second BWP.

3. The method of claim 2, wherein detecting the EOB indication includes receiving an uplink (UL) EOB indication from an application executed at the UE or a zero buffer indication.

4. The method of claim 2, wherein detecting the EOB indication includes receiving a downlink (DL) EOB indication from a network entity.

5. The method of claim 2, wherein performing the BWP switching from the first BWP to the second BWP includes:
switching to a default BWP as the second BWP; or
selecting, based on a BWP size, the second BWP from among a plurality of BWPs.

6. The method of claim 2, wherein detecting the EOB indication includes detecting the EOB indication during a discontinuous communication active phase of the UE, the method further comprising:
during the next phase of discontinuous communication, transmitting data to a network entity via the second BWP.

7. The method of claim 2, wherein performing the BWP switching from the first BWP to the second BWP includes:
transitioning from the first BWP to the second BWP based on expiration of a BWP switching delay period.

8. The method of claim 2, wherein performing the BWP switching from the first BWP to the second BWP includes:
transitioning from the first BWP to the second BWP based on expiration of a modified BWP switching delay period, and
wherein:
the modified BWP switching delay period includes a BWP switching delay period and an offset value added to the BWP switching delay period, and
the offset value is specified in a radio resource control (RRC) message, a medium access control (MAC)-control element (CE), or a downlink control information (DCI).

9. The method of claim 2, wherein the second BWP is operable to transmit any one or more of:
a mobility measurement signal,
a control signal,
a data signal,
a response to a wakeup signal (WUS) received from a network entity,
a control wakeup signal (C-WUS) configured to place the network entity into an active state, and
a scheduling request of one or more logical channel groups (LCGs).

10. The method of claim 2, further comprising:
receiving, at the UE, an indication from a network entity, the indication indicating to perform BWP switching from the first BWP to the second BWP, wherein:
the indication is in addition to the EOB indication,
the indication is received after occurrence of a threshold number of physical downlink control channel (PDCCH) monitoring occasions or within a particular time period,
at least a portion of the particular time period corresponds to a BWP switching delay, and
the BWP switching from the first BWP to the second BWP is performed in response to receiving the indication after the occurrence of the threshold number of PDCCH monitoring occasions or within the particular time period.

11. The method of claim 10, further comprising:
receiving downlink control information (DCI) that includes the indication, wherein the DCI is a non-scheduling DCI.

12. The method of claim 2, wherein performing the BWP switching from the first BWP to the second BWP includes reducing a quantity of resource blocks (RBs) in the first BWP to generate the second BWP, removing interlaced RBs from the first BWP to generate the second BWP, or a combination thereof.

13. An apparatus for wireless communication, the apparatus comprising:
at least one processor; and
a memory coupled to the at least one processor, wherein the at least one processor is configured to:
detect an end of burst (EOB) indication, the EOB indication indicating an end of a communicated data frame; and
in response to detection the EOB indication, transition from an active state to a low energy state during a next phase of discontinuous communication.

14. The apparatus of claim 13, wherein, to transition from the active state to the low energy state, the at least one processor is configured to perform bandwidth part (BWP) switching from a first BWP to a second BWP, and wherein the at least one processor is further configured to:
receive a configuration message from a base station.

15. The apparatus of claim 14, wherein the configuration message includes one or more parameters associated with performing the BWP switching from the first BWP to the second BWP, wherein the configuration message is received during a radio resource control (RRC) procedure, and wherein the one or more parameters indicate:
a size of the second BWP,
a first time period that transpires from communicating via the first BWP to communicating via the second BWP,
a duration of a second time period to communicate via the second BWP, or
a combination thereof.

16. The apparatus of claim 15, wherein the first time period includes a BWP switching delay period, a modified BWP switching delay period, a threshold number of physical downlink control channel (PDCCH) monitoring occasions, or a combination thereof.

17. The apparatus of claim 14, wherein the at least one processor is further configured to:
send, to a network entity, a BWP switching preference indication, the BWP switching preference indication indicating a BWP switching preference, an expected occurrence time of the next phase of discontinuous communication, or a combination thereof.

18. The apparatus of claim 17, wherein the BWP switching preference includes:
an identification of the second BWP,
a size of the second BWP,
a time period during which to communicate via the second BWP, or
a combination thereof.

19. The apparatus of claim 13, wherein, to transition from the active state to the low energy state, the at least one processor is configured to switch from communicating according to a first search space set group (SSSG) to communicating according to a second SSSG.

20. The apparatus of claim 19, wherein the first SSSG is associated with a first quantity of physical downlink control channel (PDCCH) monitoring occasions, and wherein the second SSSG is associated with a second quantity of PDCCH monitoring occasions that is less than the first quantity.

21. The apparatus of claim 19, wherein the first SSSG and the second SSSG are indicated by downlink control information (DCI), a medium access control (MAC)-control element (CE), or a radio resource control (RRC) message, and wherein, to switch from the first SSSG to the second SSSG, the at least one processor is configured to:
transition from the first SSSG to the second SSSG based on expiration of a particular time period corresponding to a quantity of physical downlink control channel (PDCCH) monitoring occasions associated with the first SSSG, wherein the particular time period is indicated by another DCI, another MAC-CE, or another RRC message.

22. A non-transitory computer-readable storage medium storing instructions that, when executed by one or more processors, cause the one or more processors to perform operations for wireless communication, the operations comprising:
detecting an end of burst (EOB) indication, the EOB indication indicating an end of a communicated data frame; and
in response to detecting the EOB indication, transitioning from an active state to a low energy state during a next phase of discontinuous communication.

23. The non-transitory computer-readable storage medium of claim 22, wherein detecting the EOB indication includes receiving an uplink (UL) EOB indication from an application, and wherein the operations further comprise:
refraining from decoding an UL grant when in the low energy state.

24. The non-transitory computer-readable storage medium of claim 23, wherein refraining from decoding the UL grant includes refraining from decoding the UL grant during a particular time period that corresponds to occurrence of a threshold number of physical downlink control channel (PDCCH) monitoring occasions, and wherein the particular time period is indicated by a radio resource control (RRC) message, a medium access control (MAC)-control element (CE), or a downlink control information (DCI).

25. The non-transitory computer-readable storage medium of claim 24, wherein the threshold number of PDCCH monitoring occasions is based on a search space set group (SSSG).

26. An apparatus for wireless communication, the apparatus comprising:
means for detecting an end of burst (EOB) indication, the EOB indication indicating an end of a communicated data frame; and
means for transitioning from an active state to a low energy state during a next phase of discontinuous communication, the transitioning performed in response to detecting the EOB indication.

27. The apparatus of claim 26, wherein the means for detecting an EOB indication includes means for receiving a downlink (DL) EOB indication from a network entity, and wherein the apparatus further comprises:
means for monitoring for scheduling downlink control information (DCI) and not for other DCI when in the low energy state.

28. The apparatus of claim 27, wherein the means for monitoring for the scheduling DCI and not for the other DCI is configured to monitor for the scheduling DCI with a first periodicity that is longer than a second periodicity with which monitoring was performed for the scheduling DCI prior to receiving the DL EOB indication.

29. The apparatus of claim 27, wherein the means for monitoring for the scheduling DCI and not for the other DCI includes is configured to monitor for the scheduling DCI during a time period indicated by a radio resource control (RRC) message, a medium access control (MAC)-control element (CE), or a DCI, and wherein the scheduling DCI includes an indication to switch from a first search space set group (SSSG) to a second SSSG.

30. The apparatus of claim 27, wherein the means for monitoring for the scheduling DCI and not for the other DCI is configured to monitor for the scheduling DCI in a first search space set group (SSSG) that is less dense than a second SSSG corresponding to the active state.
